(19) United States
(12) Patent Application Publication
(10) Pub. No.: US 2016/0275249 A1
(43) Pub. Date: Sep. 22, 2016

(54) METHOD OF MANAGING PERSONAL HEALTH INFORMATION AND DEVICE THEREOF

(71) Applicant: SAMSUNG ELECTRONICS CO., LTD., Suwon-si (KR)

(72) Inventors: Sung-hwa LEE, Anyang-si (KR); Chang-sub LEE, Mokpo-si (KR); Jong-rip LEE, Suwon-si (KR)

(73) Assignee: SAMSUNG ELECTRONICS CO., LTD., Suwon-si (KR)

(21) Appl. No.: 14/876,283

(22) Filed: Oct. 6, 2015

(30) Foreign Application Priority Data
Mar. 19, 2015 (KR) 10-2015-0038243

(51) Int. Cl. G06F 19/00

(52) U.S. Cl. CPC G06F 19/323

(57) ABSTRACT

A mobile device which may be managed by a subject of a medical examination, the mobile device including: a communicator configured to receive first medical information that is obtained by performing an examination of a first user, from at least one of a first medical device and a first server; a memory configured to store the first medical information; and a controller configured to control the communicator to generate corrected first medical information by performing an inter-compatibility process on the first medical information, wherein the inter-compatibility process causes the corrected first medical information to be usable in a second medical device or a second server which is different from the first medical device or the first server, and transmit the corrected first medical information to at least one of the second medical device or the second server.

### CROSS-REFERENCE TO RELATED APPLICATION

This application claims priority from Korean Patent Application No. 10-2015-0038243, filed on Mar. 19, 2015 in the Korean Intellectual Property Office, the disclosure of which is incorporated herein in its entirety by reference.

### BACKGROUND

1. Field

One or more exemplary embodiments relate to a method and apparatus for processing and managing an examination result when an individual receives an examination at a hospital by using a medical device.

2. Description of the Related Art

With the development of medical services and medical information technology, when individuals visit a hospital and receive a medical service or an examination by using a medical device, an electronic personal health record (PHR), which corresponds to a result of the examination, is stored in the hospital where the individuals have received the examination.

If the PHR, which is the result of the examination that individuals have received in hospitals, is stored only in a server of individual hospitals, such as an electronic medical record (EMR) system of the hospitals, etc., previous examination records are not available for use, when an individual, who has received an examination in one hospital, has to get an examination in another hospital.

Previous medical information of an individual has a significant importance for an examination process which determines how one's health state has changed over a long time and detects if there are any symptoms of a disease. However, if one's personal medical information is stored only in each individual hospital, one has to visit the hospitals that were previously visited, one by one, to collect records, before visiting a new hospital. Nevertheless, if a centralized administration server for the integration of medical information among hospitals is operated by other institutions than medical institutions, legal issues and privacy policy issues could be confronted.

Therefore, there is a need for a method and apparatus for effectively managing and storing patient's medical information, by which previous examination records can be utilized without infringing privacy rights.

### SUMMARY

One or more exemplary embodiments include a method and apparatus for effectively managing and storing medical information of a patient.

Additional aspects will be set forth in part in the description which follows and, in part, will be apparent from the description, or may be learned by practice of the presented exemplary embodiments.

According to an aspect of an exemplary embodiment, there is provided a mobile device which may be managed by a subject of a medical examination, the mobile device including: a communicator configured to receive first medical information that is obtained by performing an examination of a first user, from at least one of a first medical device and a first server; a memory configured to store the first medical information; and a controller configured to control the communicator to generate corrected first medical information by performing an inter-compatibility process on the first medical information, wherein the inter-compatibility process causes the corrected first medical information to be usable in a second medical device or a second server which is different from the first medical device or the first server, and transmit the corrected first medical information to at least one of the second medical device or the second server.

The controller may be configured to control the communicator to transmit first identification information of the first user to the first server.

The controller may be configured to control the communicator to transmit second identification information of the first user to at least one of the first medical device and the first server, and the communicator may be configured to receive the first medical information from the first medical device if the first identification information and the second identification information correspond to each other.

The memory may be configured to store second medical information corresponding to a result of a previously performed examination of the first user.

The controller may be configured to control the communicator to receive from the first server a request for transmitting third medical information which is at least one piece of medical information, which is not stored in the first server, the third medical information being included in the second medical information, and transmit the third medical information to the first server.

The controller may be configured to select the third medical information from the second medical information, based on first retention information received from the first server, wherein the retention information indicates a medical information retention situation of the first server.

The controller may be configured to control the communicator to receive from the second server a request for transmitting fourth medical information, the fourth medical information being at least one piece of medical information which is not stored in the second server, the fourth medical information including the first medical information; receive second retention information indicating a medical information retention situation of the second server from the second server; select the fourth medical information to be transmitted to the second server based on the received second retention information; and transmit the fourth medical information to the second server.

The communicator may be configured to transmit or receive data by using at least one of Bluetooth, radio frequency identification (RFID), barcode, QRcode, near field communication (NFC), Wi-Fi direct (WFD), ultra wideband (UWB), ZigBee, and Ant+.

The controller may be configured to control the communicator to transmit network information of the mobile device to at least one of the first medical device and the first server, and receive the first medical information based on the network information.

According to an aspect of another exemplary embodiment, there is provided a medical device which manages personal medical information, the medical device including: a controller configured to control the medical device to perform an examination of a first user, and transmit first medical information, which is a result of the examination, to at least one of a mobile device and a first server, in response to receiving a request for transmitting the first medical information from the at least one of the mobile device and the first server, and a communicator configured to transmit the first medical information to at least one of the mobile device and the first server.

The communicator may be configured to receive first identification information of the first user from at least one of the mobile device and the first server, and in response to receiving the first identification information, the controller may be configured to perform the examination in correspondence to the first identification information.

The communicator may be configured to receive second identification information of the first user from the at least one of the mobile device and the first server, and if the first identification information and the second identification information correspond to each other, the controller may be configured to control the communicator to transmit the first medical information to the mobile device.

The communicator may be configured to transmit or receive data by using at least one of Bluetooth, radio frequency identification (RFID), barcode, QRcode, near field communication (NFC), Wi-Fi direct (WFD), ultra wideband (UWB), ZigBee, and Ant+.

According to an aspect of another exemplary embodiment, there is provided a method of managing personal medical information via a mobile device, the method including: sending a request for first medical information obtained by performing an examination of a first user via a first medical device, to at least one of the first medical device and a first server; receiving the first medical information from at least one of the first medical device and the first server; storing the first medical information; generating corrected first medical information by performing an inter-compatibility process on the first medical information, wherein the inter-compatibility process causes the first medical information to be usable in a second medical device or a second server which is different from the first medical device or the first server; and transmitting the corrected first medical information to at least one of the second medical device and the second server.

The method may include transmitting first identification information of the first user to the first server, and wherein the receiving of the first medical information comprises: transmitting second identification information of the first user to the first medical device and the first server; and receiving the first medical information from the first medical device if the first identification information and the second identification information correspond to each other.

The method may include storing second medical information corresponding to a result of the examination of the first user.

The method may include receiving from the first server a request for transmitting third medical information which is at least one piece of medical information, which is not stored in the first server, the third medical information being included in the second medical information of the first user; and transmitting the third medical information to the first server.

The transmitting of the third medical information may include receiving first retention information indicating a medical information retention situation of the first server from the server; and selecting the third medical information that is to be transmitted, based on the first retention information.

The method may include receiving from the second server a request for transmitting fourth medical information, the fourth medical information being one piece of medical information which is not stored in the second server, the fourth medical information including the first medical information; receiving second retention information indicating a medical information retention situation of the second server from the second server; selecting the fourth medical information that is to be transmitted, based on the received second retention information; and transmitting the fourth medical information to the second server.

The method may include transmitting network information of the mobile device to at least one of the first medical device and the first server, wherein the receiving of the first medical information may be performed based on the network information.

According to an aspect of another exemplary embodiment, there is provided a method of managing personal medical information via a medical device, the method including performing an examination of a first user; receiving a request for first medical information, the first medical information being a result of the examination, from at least one of a mobile device and a first server; and transmitting the first medical information to at least one of the mobile device and the first server.

The performing of the examination may include receiving first identification information of the first user from the at least one of the mobile device and the first server; and performing the examination in correspondence to the first identification information.

The transmitting of the first medical information may include: receiving second identification information of the first user from the at least one of the mobile device and the first server; and if the first identification information and the second identification information correspond to each other, transmitting the first medical information to the mobile device.

According to another aspect of an exemplary embodiments, a non-transitory computer-readable recording medium may have embodied thereon a computer program for executing the methods above.

According to an aspect of another exemplary embodiment, there is provided a method of managing medical information, the method including receiving a request from a mobile device for first medical information, the first medical information being a result of an examination of a user by a medical device; receiving from the mobile device first identification information of the first user; transmitting to the medical device the first identification information to the first user; receiving the first medical information from the first medical device; transmitting the first medical information to the mobile device.

Transmitting of the first medical information may include receiving second identification information of the first user; and transmitting the first medical information if the first identification information and the second identification information correspond to each other.

The method may include transmitting a request for third medical information to the mobile device; transmitting a retention information to the mobile device; and receiving third medical information from the mobile device.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 is a block diagram of a mobile device according to an exemplary embodiment;

FIG. 2 is a detailed block diagram of a mobile device according to an exemplary embodiment;

FIG. 3 is a block diagram of a medical device according to an exemplary embodiment;

FIG. 4 is a view for describing a flow of information among a mobile device, a medical device, and a first server, according to an exemplary embodiment;

FIG. 5 is a flowchart of a method of managing first medical information via a mobile device, according to an exemplary embodiment;

FIG. 6 is a flowchart of a method of managing first medical information via a mobile device, according to another exemplary embodiment;

FIG. 7 is a flowchart of a method of processing and storing personal medical information, according to another exemplary embodiment;

FIG. 8 is a flowchart of a method of processing and storing personal medical information among a mobile device, a medical device, and a first server, according to another exemplary embodiment;

FIG. 9 is a view for describing a flow of information among a mobile device, a medical device, a first server, and a second server, according to another exemplary embodiment;

FIG. 10 is a flowchart of a method of processing and storing personal medical information, according to another exemplary embodiment;

FIG. 11 is a flowchart of a method of processing and storing personal medical information among a mobile device, a medical device, a first server, and a second server, according to another exemplary embodiment;

FIG. 12 is a view illustrating a process of conducting registration with respect to a first server corresponding to a hospital visited, via a mobile device;

FIG. 13 is a view illustrating a relationship among a mobile device, a first server, and a medical device when conducting registration via a mobile device;

FIG. 14 is a view illustrating a process of receiving first medical information from at least one of a first server and a medical device, via a mobile device;

FIG. 15 is a view illustrating a process of receiving a request for transmitting medical information from a first server, and of transmitting the medical information to the first server, via a mobile device; and

FIGS. 16 through 18 are views for describing a process in which a mobile device receives first medical information from a first server and transmits to a second server corrected first medical information which is generated by performing an inter-compatibility process on the first medical information, according to an exemplary embodiment.

### DETAILED DESCRIPTION

The advantages and features of the exemplary embodiments and methods of accomplishing them will be apparent from the description below and the accompanying drawings. Exemplary embodiments may, however, be embodied in many different forms and should not be construed as being limited to exemplary embodiments set forth herein. Rather, these exemplary embodiments are provided so that this disclosure will be thorough and complete and will fully convey the exemplary embodiments to those of ordinary skill in the art. The spirit and scope are defined by the appended claims.

The terms used herein will be briefly described and then several exemplary embodiments will be described in detail.

In the present disclosure, general terms that are widely used have been selected, if possible, in consideration of functions of exemplary embodiments, but non-general terms may be selected according to the intentions of technicians in the this art, precedents, or new technologies, etc. Also, some terms may be arbitrarily chosen by the present applicant. In this case, the meanings of these terms will be explained in corresponding parts of the present disclosure in detail. Thus, the terms used herein should be defined not based on the names thereof but based on the meanings thereof and the whole context of exemplary embodiments.

In the present disclosure, it should be understood that the terms, such as “include” or “have,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added. Also, the term “unit” should be understood as software or a hardware element, such as a field-programmable gate array (FPGA) or an application specific integrated circuit (ASIC). The term “unit” is capable of performing functions. However, the term “unit” is not limited to software or hardware. The term “unit” may be an element that can be configured to be included in an addressable storage medium or can be configured to reproduce one or more processors. Thus, examples of the term “unit” may include elements (such as software elements, object-oriented software elements, class elements, and task elements), processes, functions, attributes, procedures, subroutines, segments of program code, drivers, firmware, micro-codes, circuits, data, a database, data structures, tables, arrays, and variables. Functions provided in elements and units may be combined using a smaller number of elements and units or may be subdivided using additional elements and units.

As used herein, the term “and/or” includes any and all combinations of one or more of the associated listed items. Expressions such as “at least one of,” when preceding a list of elements, modify the entire list of elements and do not modify the individual elements of the list.

Hereinafter, exemplary embodiments will be described in detail with reference to the accompanying drawings so that those of ordinary skill in the art can easily accomplish them. Also, parts that are not related to describing exemplary embodiments are omitted in the drawings for clarity.

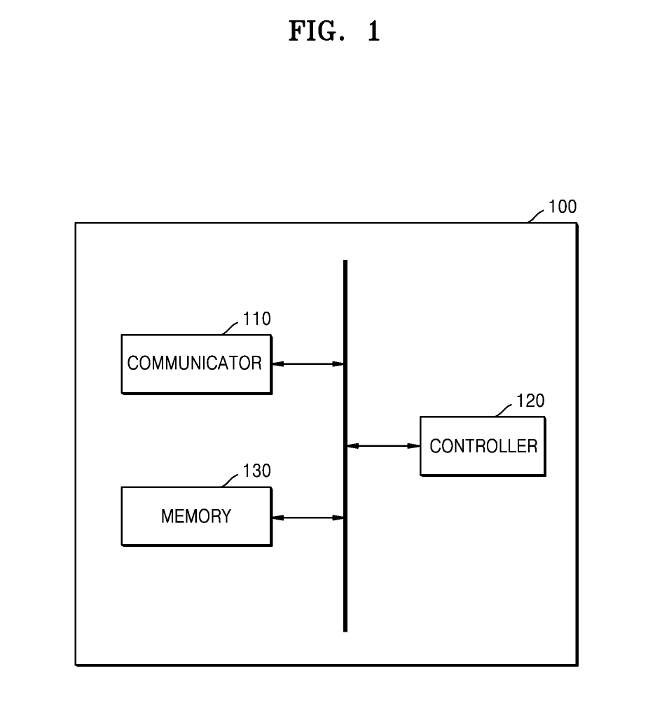

FIG. 1 is a block diagram of a mobile device 100 according to an exemplary embodiment.

The mobile device 100 refers to any electronic device which is capable of storing and processing medical information which includes a medical image, a patient treatment record, patient diagnosis information, etc. Also, the mobile device 100 may exchange medical information with at least one of a medical-related server and a medical device, via a wired or wireless network.

The mobile device 100 may include a controller 120 configured to request at least one of a medical device and a first server to transmit first medical information which is obtained by performing an examination of a first user, a communicator 110 configured to transmit or receive the first medical information to or from the at least one of the medical device and the first server, and a memory 130 configured to store the received first medical information.

The communicator 110 may receive medical information of a user of the mobile device 100, from other devices than the mobile device 100, for example, a medical device or a server. In addition, when the mobile device 100 receives a request for medical information, from other mobile devices, the mobile device 100 may transmit the received and stored medical information to the other mobile devices. The memory 130 stores data so that the mobile device 100 may store any data that is received by the communicator 110. The data stored in the memory 130 of the mobile device 100 may be transmitted to other mobile devices via the communicator 110. For example, medical information that is stored in the memory 130 of the mobile device 100 may be transmitted to a server. The controller 120 may control the communicator 110 or the memory 130 to send a request for transmitting the first medical information which is obtained by performing an examination of a first user, to at least one of the medical device or the first server, according to an exemplary embodiment. The controller 120 may control the memory 130 to store medical information regardless of whether the medical information meets a predetermined standard which is used in the medical information management field, and when the medical information that is stored in the memory 130 is transmitted to other mobile devices, the controller 120 may convert the medical information into a format which is capable of being used in the other mobile devices. Detailed aspects of exemplary embodiments will be described below.

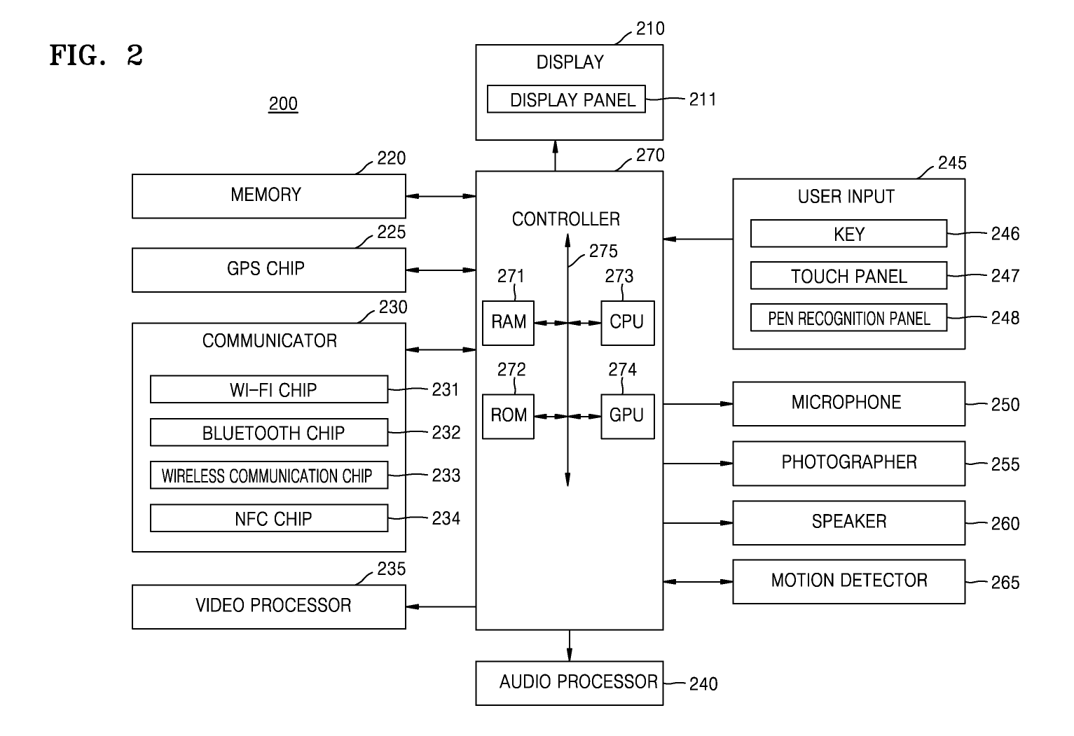

FIG. 2 is a detailed block diagram of a mobile device 200 according to an exemplary embodiment. The mobile device 200 may include at least one of a display 210, a controller 270, a memory 220, a global positioning system (GPS) chip 225, a communicator 230, a video processor 235, an audio processor 240, a user input 245, a microphone unit 250, a photographer 255, a speaker 260, and a motion detector 265. Here, the mobile device 200 of FIG. 2 may correspond to the mobile device 100 of FIG. 1. In detail, the communicator 230, the controller 270, and the memory 220 of the mobile device 200 of FIG. 2 may respectively correspond to the communicator 110, the controller 120, and the memory 130 of FIG. 1.

The display unit 210 may include a display panel 211 and a controller for controlling the display panel 211. The display panel 211 may be realized as various types of displays, such as liquid crystal displays (LCD), organic light-emitting diode (OLED) displays, active-matrix organic light-emitting diode (AM-OLED) displays, and plasma display panels (PDP). The display panel 211 may be realized to be flexible, transparent, and wearable. The display unit 210 may be combined with a touch panel 247 of the user input 245 to be provided as a touch screen. For example, the touch screen may include an integral module in which the display panel 211 and the touch panel 247 are stacked.

The memory 220 may include at least one of an internal memory and an external memory. The memory 220 may correspond to the memory 130 of FIG. 1.

The internal memory may include at least one of, for example, volatile memories (for example, dynamic random-access memory (DRAM), static random-access memory (SRAM), and synchronous dynamic random-access memory (SDRAM), non-volatile memories (for example, one time programmable read-only memory (OTPROM), programmable read-only memory (PROM), erasable and programmable read-only memory (EPROM), electrically erasable and programmable read-only memory (EEPROM), mask read-only memory, and flash read-only memory), a hard disk drive (HDD), and a solid state drive (SSD). According to an exemplary embodiment, the controller 270 may process a command or data received from a non-volatile memory or from at least one of other components by loading the command or the data in the volatile memory. Also, the controller 270 may store the data received or generated from other components in a non-volatile memory.

The external memories may include at least one selected from, for example, a compact flash (CF) memory, a secure digital (SD) memory, a micro secure digital (Micro-SD) memory, a mini secure digital (Mini-SD) memory, an extreme digital (xD) memory, and a memory stick.

The memory 220 may store various programs and data used for an operation of the mobile device 200. For example, the memory 220 may permanently or semi-permanently store at least a portion of content that is to be displayed on a lock screen.

The controller 270 may control the display unit 210 such that a portion of the content stored in the memory 220 is displayed on the display unit 210. In other words, the controller 270 may display a portion of the content stored in the memory 220 on the display 210. The controller 270 may correspond to the controller 120 of FIG. 1.

The controller 270 may include at least one of a random-access memory (RAM) 271, read-only memory (ROM) 272, a central processing unit (CPU) 273, a graphic processing unit (GPU) 274, and a bus 275. The RAM 271, the ROM 272, the CPU 273, and the GPU 274 may be connected with one another via the bus 275.

The CPU 273 accesses the memory 220 and performs a boot operation by using O/S stored in the memory 220. Also, the CPU 273 performs various operations by using various programs, content, and data stored in the memory 220.

A set of command languages for a system boot operation is stored in the ROM 272. For example, when a turn-on command is input to the mobile device 200 and power is supplied to the mobile device 200, the CPU 273 may copy the 0/S stored in the memory 220 in the RAM 271, according to the command language stored in the ROM 272, and may execute the 0/S to boot the system. When the booting is completed, the CPU 273 may copy various programs stored in the memory 220 in the RAM 271 and execute the programs copied in the RAM 271 to perform various operations. The GPU 274 displays a user interface (UI) screen on a portion of the display unit 210, when the booting of the mobile device 200 is completed. In detail, the GPU 274 may generate a screen in which electronic files including various objects, such as content, icons, and menus are displayed. The GPU 274 may calculate feature values, such as coordinate values, shapes, sizes, and colors of displayed objects in correspondence to a layout of the screen. Also, the GPU 274 may generate screens of various layouts including objects, based on the calculated feature values. The screens generated by the GPU 274 may be provided to the display unit 210 and may be each displayed on a portion of the display unit 210.

The GPS chip 225 may receive a global positioning system (GPS) signal from a GPS satellite to calculate a current location of the mobile device 200. The controller 270 may calculate a user location by using the GPS chip 225, when a navigation program is used or on other occasions when a current user location is needed.

The communicator 230 may perform communication with various types of external devices, according to various types of communication methods. The communicator 230 may include at least one of a Wi-Fi chip 231, a Bluetooth chip 232, a wireless communication chip 233, and a near-field communication (NFC) chip 234. The controller 270 may perform communication with various external devices via the communicator 230. The communicator 230 may correspond to the communicator 110 of FIG. 1.

The Wi-Fi chip 231 and the Bluetooth chip 232 may perform communication by respectively using a Wi-Fi method and a Bluetooth method. When the Wi-Fi chip 231 or the Bluetooth chip 232 is used, various connection information such as a service set identifier (SSID) and a session key is firstly transferred or received to or from another device, and then, communication is established by using the various connection information, in order to transfer or receive various information to or from another device. The wireless communication chip 233 refers to a chip performing communication according to various communication standards, such as IEEE, ZigBee, 3^{rd} generation (3G), 3^{rd} generation partnership project (3GPP), and long term evolution (LTE). The NFC chip 234 refers to a chip operating in a near field communication (NFC) method using 13.56 MHz band from among various radio frequency identification (RF-ID) bands, including 135 kHz, 13.56 MHz, 433 MHz, 860-960 MHz, and 2.45 GHz.

The video processor 235 may process content received via the communicator 230 or video data included in content stored in the memory 220. The video processor 235 may perform various image processing on the video data, such as decoding, scaling, noise filtering, frame rate conversion, and resolution conversion.

The audio processor 240 may process content received via the communicator 230 or audio data included in the content stored in the memory 220. The audio processor 240 may perform various processing on the audio data, such as decoding, amplification, and noise filtering.

The controller 270 may drive the video processor 235 and the audio processor 240 when a reproducing program with respect to multimedia content is executed, in order to reproduce the corresponding content. The speaker 260 may output audio data generated by the audio processor 240.

The user input 245 may receive an input of various command languages from a user. The user input 245 may include at least one of a key 246, the touch panel 247, and a pen recognition panel 248.

The key 246 may include various types of keys, such as a mechanical button and a wheel, formed in various portions of an external body of the mobile device 200, such as a front portion, a side portion, and a rear portion of the mobile device 200.

The touch panel 247 may sense a touch input of a user and may output a touch event value corresponding to the sensed touch input. When the touch panel 247 is formed as a touch screen by being combined with the display panel 211, the touch screen may be realized as various types of touch sensors, such as a capacitive type touch sensor, a decompression type touch sensor, and a piezoelectric type touch sensor. The capacitive type touch sensor uses a method of calculating a touch coordinate by sensing fine electricity caused by a human body part of a user when a part of the human body of the user touches a surface of the touch screen, by using a dielectric coated on the surface of the touch screen. The decompression type touch sensor uses a method of including two electrode plates equipped in the touch screen and calculating a touch coordinate by sensing a current flow due to the upper and bottom electrode plates contacting each other at a touched point where a user touched a screen. The touch event occurring on the touch screen may be generated mainly by a finger of the user, but may also be generated by an object of a conductive material which may cause a change in capacitance.

The pen recognition panel 248 may sense a proximate input of a pen or a touch input of a pen according to an operation of a touch pen (for example, a stylus pen) or a digitizer pen of a user, and may output a pen proximate event or a pen touch event that is sensed. The pen recognition panel 248 may be realized for example as an EMR method and may sense a touch or proximate input, according to a change in strength of an electromagnetic field due to an approach or a touch of a pen. In detail, the pen recognition panel 248 may be formed by including an electronic induction coil sensor (not shown) having a grid structure, and an electronic signal processing unit (not shown) sequentially providing indirect signals having pre-determined frequencies in each loop coil of the electronic induction coil sensor. If there is a pen equipped with a resonator circuit, around the loop coil of the pen recognition panel 248, the magnetic field transferred from the loop coil may generate a current based on mutual electromagnetic induction, in the resonator circuit in the pen. Based on the current, an inductive magnetic field is generated from a coil forming the resonator circuit in the pen, and the pen recognition panel 248 may detect the inductive magnetic field in the loop coil in a state of signal reception, so that an approach or a touch location of the pen may be sensed. The pen recognition panel 248 may be provided below the display panel 211, by having a pre-determined area, for example, an area which may cover a display portion of the display panel 211.

The microphone 250 may receive an input of a user's sound or other noises and convert the input into audio data. The controller 270 may use the user's sound input through the microphone unit 250 in a calling operation or may convert the user's sound into audio data to store the audio data in the memory 220.

The photographer 255 may capture a still image or a video according to a control of a user. The photographer 255 may be realized in a multiple number, for example, including a front camera and a rear camera.

When the photographer 255 and the microphone 250 are provided, the controller 270 may perform a control operation according to a user's sound input through the microphone unit 250 or a user's motion recognized by the photographer 255. For example, the mobile device 200 may operate in a motion control mode or a sound control mode. When the mobile device 200 operates in a motion control mode, the controller 270 may control the photographer 255 to photograph the user and may track the motion change of the user to perform a control operation corresponding to the motion change of the user. When the mobile device 200 operates in a sound control mode, the controller 270 may analyze the user's sound input through the microphone unit 250 and may operate in a sound recognition mode that performs a control operation according to the analyzed user's sound.

The motion detector 265 may sense a motion of a body part of the mobile device 100. The mobile device 200 may rotate or may tilt in various directions. Here, the motion detector 265 may detect characteristics of the motion, such as a direction and angle of the rotation, and a tilting degree, by using at least one of various sensors, such as an earth magnetic sensor, a gyro sensor, and an acceleration sensor.

In addition, according to exemplary embodiments, the mobile device 200 may further include a universal serial bus (USB) port to which a USB connector may be connected, various external input ports for connections with various external terminals, such as a headset, a mouse, and a local area network (LAN), a digital multimedia broadcasting (DMB) chip receiving and processing a DMB signal, and various sensors.

Names of the above-described components of the mobile device 200 may vary. Also, the mobile device 200 may be formed by including one of the above-described components, by omitting some of the above-described components, or by further including additional components.

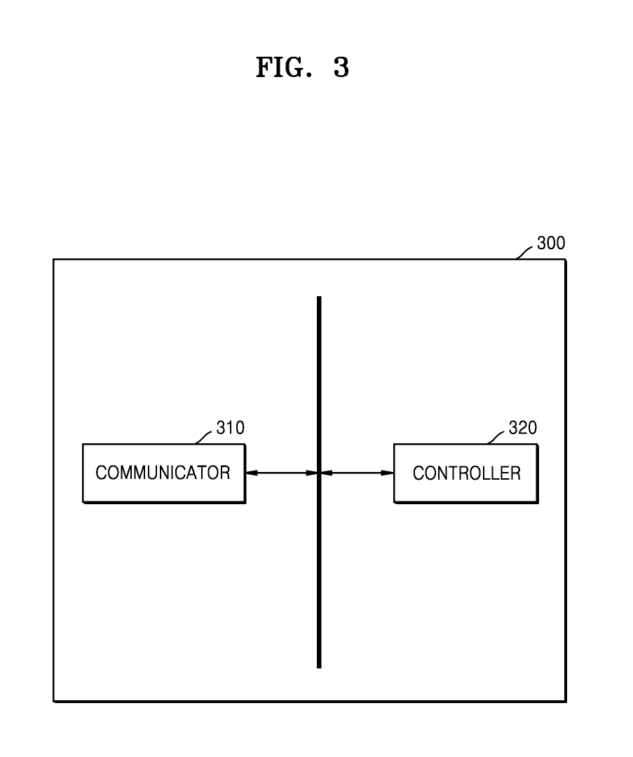

FIG. 3 is a block diagram of a medical device 300 according to an exemplary embodiment. The medical device 300 refers to any electronic device which is capable of obtaining medical data necessary for the diagnosis of a patient. In detail, the medical device 300 may be any kind of medical device, such as an X-ray device, a computed tomography (CT) device, an ultrasound device, and a magnetic resonance imaging (MRI) device, or a device for generating data of medical information or health information of a user, which indicates a personal health condition, such as in vitro diagnostic medical device. In other words, the medical device 300 may generate medical information indicating personal health conditions. A communicator 310 may transmit the medical information generated by the medical device 300 to other devices, for example, a mobile device 100 of an individual or a server, and may receive predetermined data from the other devices. A controller 320 may control the medical device 300 to perform an examination and may control the communicator 310 to transmit a result of the examination to other devices. Hereinafter, detailed aspects of the medical device 300 will be described with reference to an exemplary embodiment.

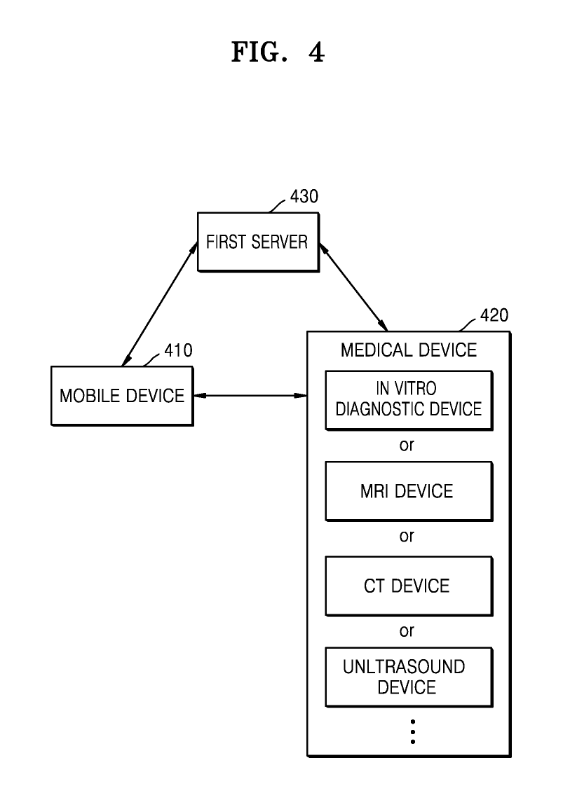

FIG. 4 is a view for describing a flow of information among a mobile device 410, a medical device 420, and a first server 430, according to an exemplary embodiment. The mobile device 410 may correspond to the mobile device 100 of FIG. 1, and the medical device 420 may correspond to the medical device 300 of FIG. 3. As a result, the mobile device may include a controller 120, a communicator 110, and a memory 130. Similarly, the medical device 420 may include a communicator 310 and controller 320.

The controller 120 of the mobile device 410 may control the communicator 110 to transmit first identification information of a first user to at least one of the medical device 420 and the first server 430. The controller 120 of the mobile device 410 may control the communicator 110 to transmit the first identification information of the first user, who has visited a hospital, to the first server 430, and in this way, a registration for the hospital service may be conducted. Also, the controller 320 of the medical device 420 may control the communicator 310 to receive second identification information from the mobile device 410, and transmit first medical information, which is a result of performing an examination of the first user corresponding to the received first or second identification information, to the mobile device 410. The controller 120 of the mobile device 410 may directly receive the medical information generated by the medical device 420 from the medical device 420, or may control the communicator 110 to receive the medical information via the first server 430 of the hospital having the medical device 420.

The medical device 420 may be any kind of device capable of generating an individual's health information or medical information, such as an in vitro diagnostic device, an MRI device, a CT device, an ultrasound device, etc. The medical device 420 may be located at a place related to a treatment of a patient, such as a predetermined hospital, to perform an examination of an individual, and may control the communicator 310 to transmit medical information, such as image data, which corresponds to an examination result, to the first server 430, which is connected to the predetermined hospital. The hospital may diagnose the individual's health condition, based on the medical information, which corresponds to the result of the examination that the individual who has visited the hospital has received. The medical device 420 may control the communicator 310 to receive the first identification information from the mobile device 410 or receive the first identification information, which was transmitted to the first server 430 by the mobile device 410, from the first server 430. The controller 320 of the medical device 420 may control the communicator 310 to determine whether the received first identification information and second identification information correspond to each other, and transmit the first medical information, which is the examination result, to the mobile device 410 or the first server 430, if the first identification information and the second identification information correspond to each other.

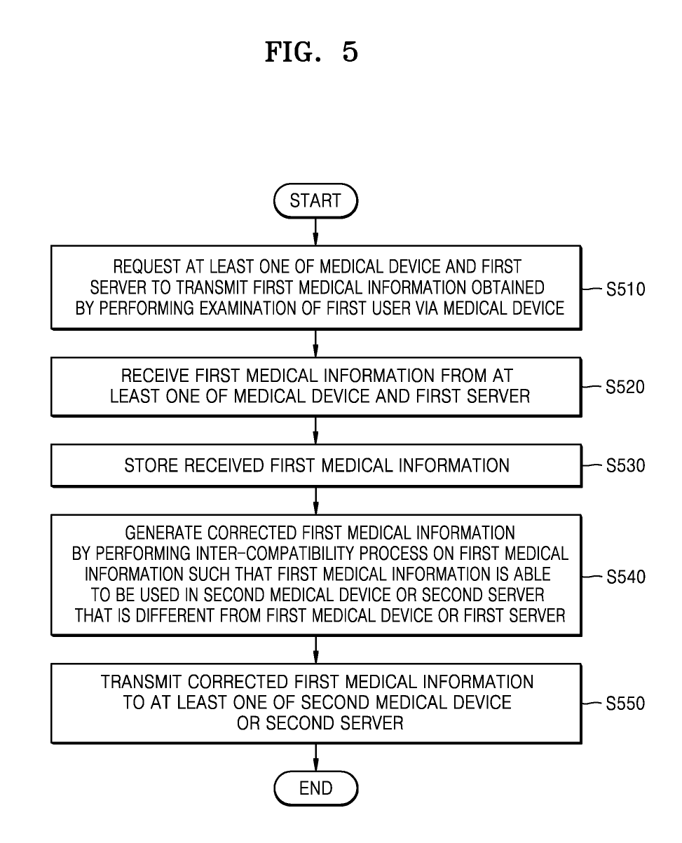

FIG. 5 is a flowchart of a method of managing the first medical information via the mobile device 410, according to an exemplary embodiment.

The controller 120 of the mobile device 410 may control the communicator 110 to send a request for transmitting the first medical information obtained by performing an examination of a first user via the medical device 420 to at least one of the medical device 420 and the first server 430, in operation S510. The controller 320 of the medical device 420 may control the communicator 310 to receive the first identification information corresponding to the first user, so that the examination is performed based on the first identification information.

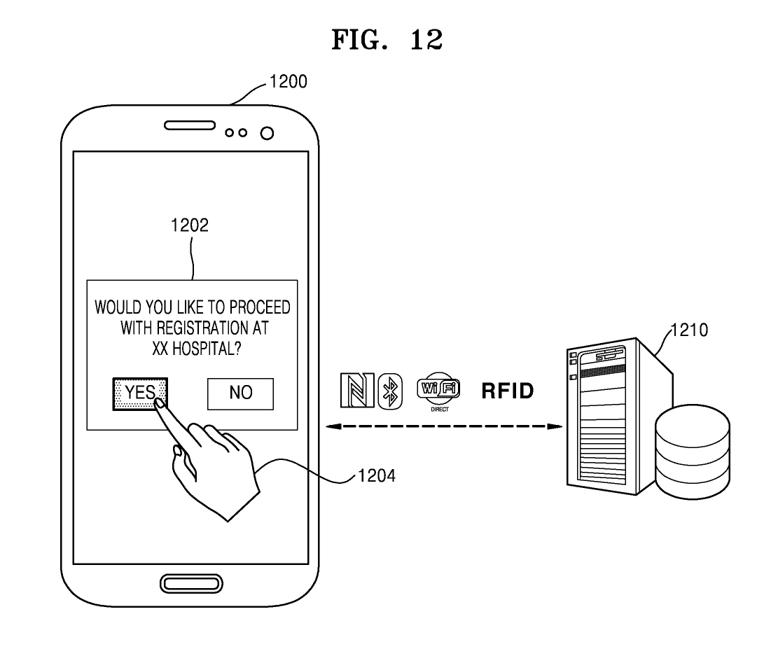

According to an exemplary embodiment, the mobile device 410 may conduct a registration process, before requesting the medical device 420 to execute an examination. By conducting the registration process, the mobile device 410 may provide schematic information about which treatment the user of the mobile device 410 is to receive in the hospital that the user visits. Due to the registration process of the mobile device 410, the user may not manually conduct registration, but may automatically conduct registration by using the mobile device 410. FIG. 12 is a view illustrating a process of conducting registration with respect to a first server 1210 corresponding to a hospital that is visited, by using a mobile device 1200. The mobile device 1200 and the first server 1210 of FIG. 12 may respectively correspond to the mobile device 410 and the first server 430 of FIG. 4. A user of the mobile device 1200 may visit a hospital and the user may conduct registration with respect to the first server 1210, by using methods based on NFC, Bluetooth, Wi-Fi direct, RFID, etc. When the registration is conducted, the mobile device 1200 may display a registration process notifying window 1202 which pops up on the display unit 210. The user may check the hospital where the registration process is conducted through the registration process notifying window 1202, and then, may proceed with the registration by making a touch input 1204 on the mobile device 1200.

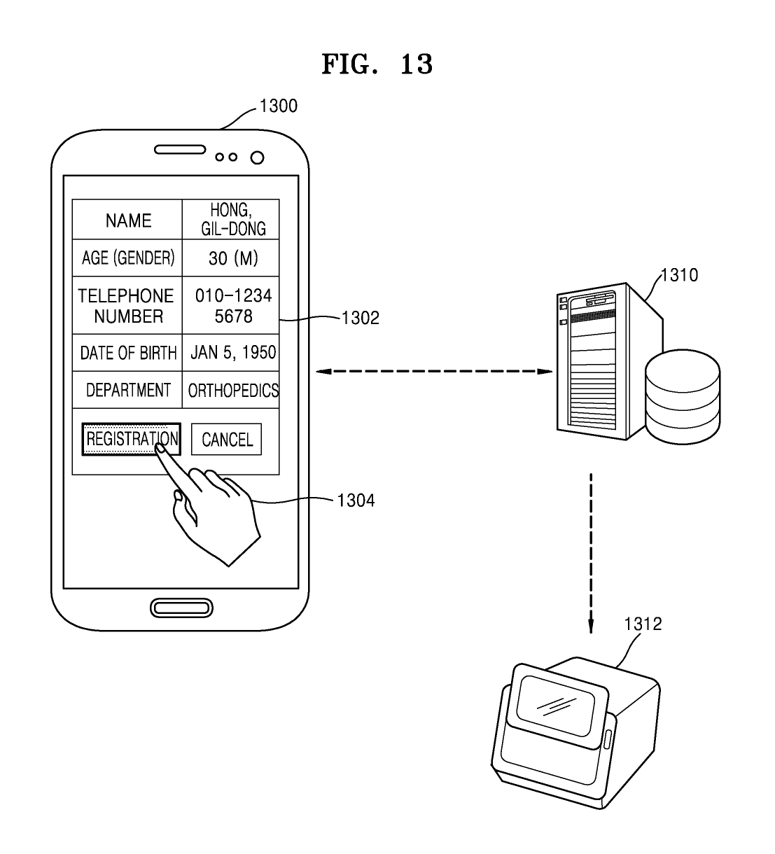

FIG. 13 illustrates a relationship among a mobile device 1300, a first server 1310, and a medical device 1312, while the mobile device 1300 conducts a registration process. The mobile device 1300 of FIG. 13 may correspond to correspond to the mobile device 410 of FIG. 4. Similarly, the first server 1310 of FIG. 13 may correspond to the first server 430 of FIG. 4, and the medical device 1312 of FIG. 13 may correspond to the medical device 420 of FIG. 4. When the mobile device 1200 determines that the mobile device 1200 is to proceed with the registration process in FIG. 12, it may be determined which information is to be provided to the first server 1310 in order to conduct the registration, by writing specific information that is to be transmitted to the first server 1310. In detail, when the mobile device 1300 determines that the mobile device 1200 is to proceed with the registration, the mobile device 1300 may display a registration information window 1302 which pops up on a display unit of the mobile device 1300. The mobile device 1300 may generate registration information including a user's name, age, gender, telephone number, date of birth, and type of treatment. When the mobile device 1300 receives an input for information transmission 1304, the mobile device 1300 may transmit the registration information to the first server 1310.

According to an exemplary embodiment, the mobile device 1300 may establish a network connection with the first server 1310 in the registration process, or may transmit network information associated with the mobile device 1300 to the first server 1310. The network information transmitted to the first server 1310 may be transmitted to the medical device 1312. Also, the first server 1310 or the medical device 1312 may transmit first medical information, which is a result of an examination performed by the medical device 1312, to the mobile device 1300 based on this network information.

Returning to FIGS. 4 and 5, the controller 120 of the mobile device 410 may control the communicator 110 to receive the first medical information, which is the result of the examination of the first user, from at least one of the medical device 420 and the first server 430, in operation S520. When the mobile device 410 requests the medical device 420 to transmit the first medical information, the controller 120 may control the communicator 110 to receive the first medical information directly from the medical device 420. When the mobile device 410 requests the first server 430 to transmit the first medical information, the controller 120 may control the communicator 110 to receive the first medical information from the first server 430. The first medical information received from the first server 430 may be the first medical information which the first server 430 received from the medical device 420.

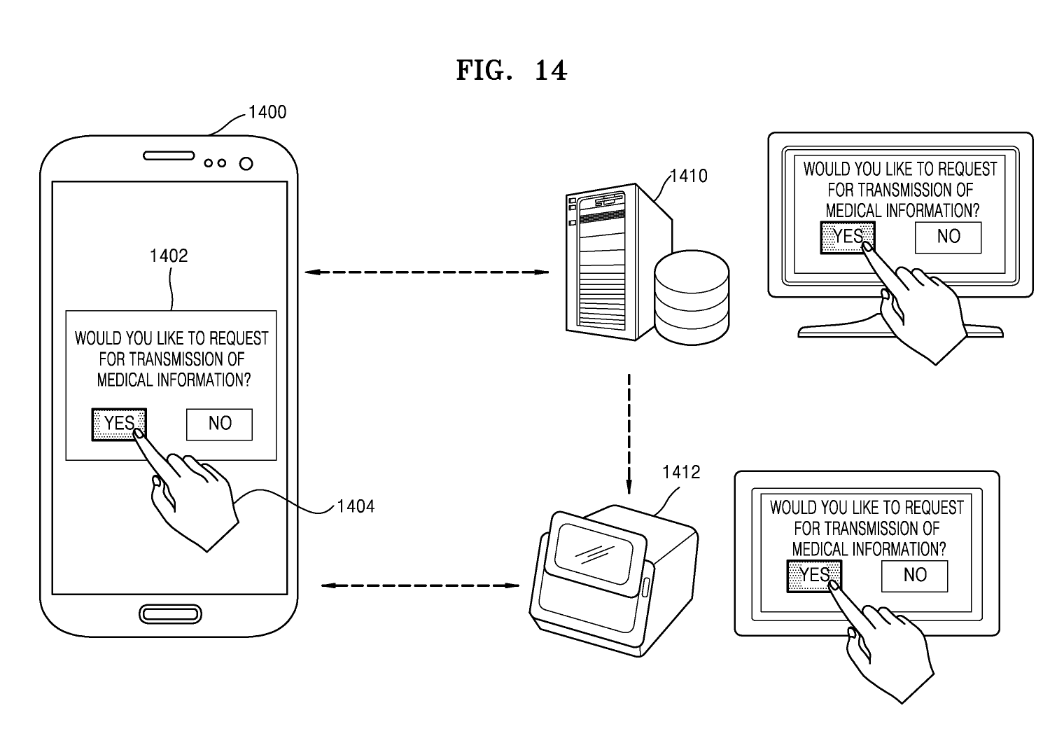

FIG. 14 is a view illustrating a process of receiving first medical information from at least one of a first server 1410 and a medical device 1412, via a mobile device 1400. The mobile device 1400 of FIG. 14 may correspond to mobile device 410 of FIG. 4, the first server 1410 of FIG. 14 may correspond to the first server 430 of FIG. 4, and the medical device 1412 of FIG. 14 may correspond to the medical device 420 of FIG. 4. The mobile device 1400 may send a request for transmitting the first medical information, to at least one of the first server 1410 and the medical device 1412, in order to receive the first medical information that is generated by performing an examination. For example, the mobile device 1400 may display a transmission request window 1402 for requesting the transmission of the first medical information, which pops up on the display unit 210. The mobile device 1400 may receive a transmission request input 1404 for receiving the first medical information and send the request for transmitting the first medical information to at least one of the first server 410 and the medical device 1412. The medical device 1412 may directly transmit the first medical information, which is the medical information generated by performing an examination, to the mobile device 1400, when the medical device 1412 receives the transmission request. Also, the first server 1410 may transmit the first medical information, which is received from the medical device 1412, to the mobile device 1400, based on the transmission request received by the first server 1410. The first server 1410 or the medical device 1412 may transmit the first medical information to the mobile device 1400 based on network information of the mobile device 1400, which is received by the first server 1410. According to an exemplary embodiment, the first server 1410 or the medical device 1412, which received the request for transmitting the medical information, may display a pop-up window regarding whether or not to approve the transmission of the first medical information, and may transmit the first medical information to the mobile device 1400, when the first server 1410 or the medical device 1412 receives an input approving the transmission of the first medical information on the displayed pop-up window. However, this is only an exemplary embodiment, and the operation of approving the request for transmitting the medical information by the first server 1410 or the medical device 1412 may be omitted. That is, when the request for transmitting the medical information is received from the mobile device 1400, the medical device 1412 may automatically transmit the first medical information, which is a result of an examination, to the mobile device 1400, based on the network information of the mobile device 1400, without the operation of approving the transmission request.

Returning to FIGS. 4 and 5, the controller 120 of the mobile device 410 may store the first medical information received in operation S520 in the memory 130 in operation S530. According to an exemplary embodiment, at least one piece of medical information, which includes the first medical information stored in the memory 130, may be stored in a format in which the medical information may be transmitted to a second server, etc., when the user visits another hospital.

In operation S540, the controller 120 of the mobile device 410 may generate corrected first medical information by performing an inter-compatibility process on the first medical information such that the first medical information can be used in a second medical device or a second server, which is different from the first medical device or the first server. In detail, the mobile device 410 may store the first medical information, which is received from the first server 430 and the first medical device 420, which is related to the first server 430, in the memory 130. The first medical information may not only be used in the first server 430, but may also be transmitted to and used in an external server which is different from the first server 430, for example, a hospital which is different from the hospital related to the first server 430. To check a patient's health condition, previous treatment records of a medical institution or exchanges of medical information is essential, and thus, when the patient should visit different hospitals, medical information, which was previously generated, needs to be received from the previous hospitals.

In this case, previously, the records of medical information were managed by using a centralized server operated by a communication company or an information technology (IT) company. However, if the server is stored in other places than hospitals, legal issues may arise, and further, an infringement of privacy rights may occur.

Thus, according to exemplary embodiments, the medical information with respect to the user of the mobile device 410 may be stored in the mobile device 410, and whenever the user visits a different hospital, the medical information of the user is transmitted to a server of the other hospital, thereby preventing the above problems. However, different hospitals may have different systems or standards for managing treatment records and medical images. In this case, the inter-compatibility between the different systems or standards may become important. According to an exemplary embodiment, the controller 120 of the mobile device 410 may generate corrected first medical information by performing an inter-compatibility process on the first medical information such that the standard corresponding to the first medical information stored in the memory 130 of the mobile device 410 can be compatible with the standard used in a second server to which the first medical information is to be transmitted.

In operation S550, the controller 120 of the mobile device 410 may control the communicator 110 to transmit the corrected first medical information generated in operation S540 to at least one of the second server and a second medical device related to the second server. Unlike the first medical information, the corrected first medical information can be compatible with the system or standard used in the second server, when the corrected first medical information is transmitted to the second server, and thus, content of the first medical information received from the first server 430 may be used in the second server.

Also, the controller 120 of the mobile device 410 may control the display unit (corresponding to display unit 210 of FIG. 2) to output a user interface screen notifying a state of data transmission or reception, while the data is received or transmitted. In detail, the user interface screen may include a type of information included in the transmitted or received data, a hospital or a medical device which generates the data, a period of time in which the data is generated, and information for the patient identification. Also, the user interface screen may include information indicating a progress of data transmission or reception.

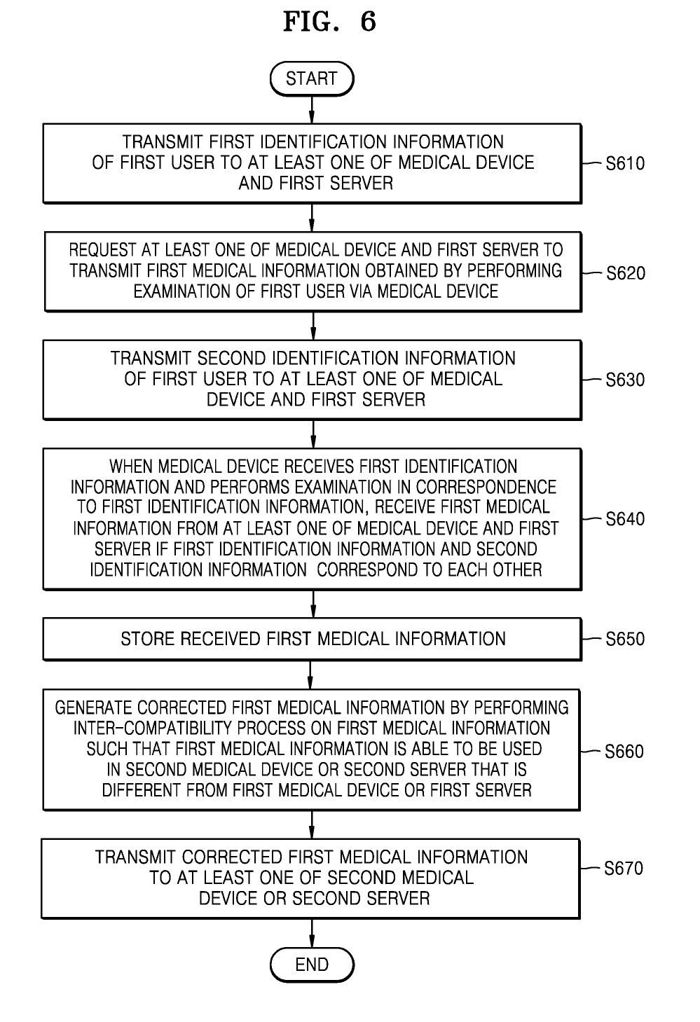

FIG. 6 is a flowchart of a method of managing first medical information via the mobile device 410, according to another exemplary embodiment.

In detail, FIG. 6 is the flowchart of the method of managing the received first medical information, in the mobile device 410, when first identification information and second identification information, which are received, correspond to each other, after determining whether the received first identification information and second identification information correspond to each other via the medical device 420.

In operation S610, the controller 120 of the mobile device 410 may control the communicator 110 to transmit the first identification information with respect to a first user to at least one of the medical device 420 and the first server 430. The first identification information may be used to perform an examination of the first user corresponding to the first identification information, via the medical device 420. The controller 320 of the medical device 420 may perform the examination of the first user corresponding to the first identification information, when receiving the first identification information from at least one of the mobile device 410 and the first server 430. When the first identification information is transmitted only to the first server 430, the first server 430 may transmit the first identification information to the medical device 420, and the controller 320 of the medical device 420 may perform the examination of the first user corresponding to the first identification information received from the first server 430.

In operation S620, the controller 120 of the mobile device 410 may control the communicator 110 to request at least one of the medical device 420 and the first server 430 to transmit the first medical information generated by performing the examination of the first user via the medical device 420. Detailed aspects with respect thereto may correspond to operation S510 of FIG. 5, and thus, their descriptions will be omitted.

In operation S630, the controller 120 of the mobile device 140 may control the communicator 110 to transmit the second identification information of the first user to the medical device 420 and the first server 430. When the second identification information is transmitted only to the first server 430, the first server 430 may control the communicator 110 to transmit the second identification information to the medical device 420. Only when the first identification information transmitted in operation S610 and the second identification information transmitted in operation S630 correspond to each other, the controller 120 may control the communicator 110 to receive the first medical information.

In operation S640, the controller 120 of the mobile device 410 may control the communicator 110 to receive the first medical information, which is a result of performing an examination in correspondence to the first identification information received by the medical device 420, if the first identification information and the second identification information correspond to each other. The controller 120 of the mobile device 410 may control the communicator 110 to directly receive the first medical information from the medical device 420, and may control the communicator 110 to receive the first medical information that the medical device 420 transmits to the first server 430, from the first server 430. For example, when the mobile device 410 requests the medical device 420 to transmit the first medical information in operation S620, the medical device 420 may transmit the first medical information to the mobile device 410, and when the mobile device 410 requests the first server 430 to transmit the first medical information in operation S620, the controller 120 may control the communicator 310 to receive the first medical information from the first server 430, which receives the first medical information from the medical device 420.

In operation S650, the controller 120 of the mobile device 410 may control the memory 130 to store the first medical information received in operation S640. Operation S650 may correspond to operation S530 of FIG. 5. At least one piece of information including the first medical information stored in the memory 130 may be stored in a format which can be transmitted to a second server, etc. when the user visits another hospital. Detailed aspects with respect thereto will be described below by referring to an exemplary embodiment.

In operation S660, the controller 120 of the mobile device 410 may generate corrected first medical information by performing an inter-compatibility process on the first medical information such that the first medical information can be used in a second medical device or a second server which is different from the first medical device or the first server. Detailed aspects with respect thereto may correspond to operation S540 of FIG. 5, and thus, their descriptions will be omitted.

In operation S670, the controller 120 of the mobile device 410 may control the communicator 110 to transmit the corrected first medical information generated in operation S660 to at least one of the second server and the second medical device related to the second server. Detailed aspects with respect thereto may correspond to operation S550 of FIG. 5, and thus, their descriptions will be omitted.

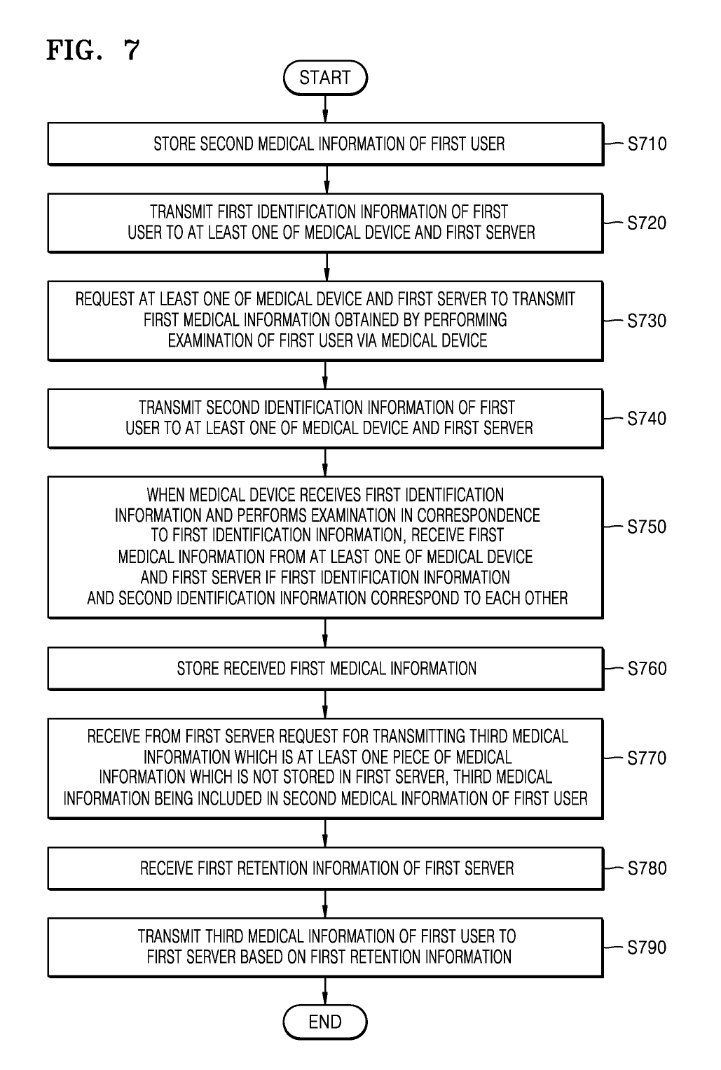

FIG. 7 is a flowchart of a method of processing and managing personal medical information, according to another exemplary embodiment.

In detail, FIG. 7 is the flowchart of the method in which the mobile device 410 stores the received first medical information and transmits third medical information, which is stored in the mobile device 410, to the first server 430, when the third medical information is not stored in the first server 430, based on first retention information.

According to an exemplary embodiment, the mobile device 410 may transmit second medical information, which corresponds to a result of a previously performed examination, in addition to the first the medical information which corresponds to the result of the current examination, to the first server 430. In addition, the second medical information may include the third medical information, which is not stored in the first server 430. Thus, the mobile device 410 may transmit the second medical information to the first server 430 when the mobile device 410 receives a request for transmitting all of the second medical information. Alternatively, the mobile device 410 may transmit only the third medical information, which is not stored in the first server 430, to the first server 430.

In operation S710, the controller 120 of the mobile device 410 may control the memory 130 to store the second medical information. The second medical information may be medical information which was already stored in the mobile device 410 when the mobile device 410 receives and stores the first medical information, or may be medical information corresponding to a result of an examination performed before the first medical information is received. For example, when the first user visits a current hospital and receives an examination by using the medical device 420, the second medical information may be previous medical information already stored in the mobile device 410, other than the first medical information, which is the result of the examination performed in the current hospital. Thus, according to an exemplary embodiment, the controller 120 of the mobile device 410 may control the memory 130 to store the second medical information in operation S710. However, the case where the mobile device 410 already stores the second medical information before storing the first medical information also belongs to this exemplary embodiment. By referring to the first medical information and the second medical information, the health condition or the medical information of the first user from the past to the present may be identified while the first user receives the medical service in the hospital.

In operation S720, the controller 120 of the mobile device 410 may control the communicator 110 to transmit the first identification information of the first user to at least one of the medical device 420 and the first server 430. Detailed aspects with respect thereto may correspond to operation S610 of FIG. 6, and thus, their descriptions will be omitted.

In operation S730, the controller 120 of the mobile device 410 may control the communicator 110 to request at least one of the medical device 420 and the first server 430 to transmit the first medical information generated by performing the examination via the medical device 420. Detailed aspects with respect thereto may correspond to operation S620 of FIG. 6, and thus, their descriptions will be omitted.

In operation S740, the controller 120 of the mobile device 410 may control the communicator 110 to transmit the second identification information of the first user to at least one of the medical device 420 and the first server 430. The second identification information is information that the mobile device 410 transmits to at least one of the medical device 420 and the first server 430 when the mobile device 410 requests the first medical information, which is the result of the examination, after the medical device 420 performs the examination of the first user corresponding to the received first identification information in operation S720.

In operation S750, when the second identification information received in operation S740 and the first identification information received in operation S720 correspond to each other, the controller 120 of the mobile device 410 may control the communicator 110 to receive the first medical information which is the result of the examination performed in correspondence to the first identification information, via the medical device 420. According to an exemplary embodiment, when in operation S720 which is before the examination is performed by the medical device 420, the controller 120 of the mobile device 410 transmits the first identification information to at least one of the medical device 420 and the first server 430, and the medical device 420 receives the first identification information and performs the examination of the first user corresponding to the first identification information so as to generate the first medical information, the controller 120 of the mobile device 410 may directly or via the first server 430 request the medical device 420 to transmit the first medical information. In this case, the controller 120 of the mobile device 410 may directly or via the first server 430 transmit the second identification information to the medical device 420. The controller 320 of the medical device 420 receiving the second identification information transmits the first medical information to the mobile device 410 when the first identification information received in operation S720 and the second identification information received in operation S740 correspond to each other. That is, before transmitting the first medical information to the mobile device 410, authentication may be performed by a process of matching the first identification information with the second identification information.

In operation S760, the controller 120 of the mobile device 410 may control the memory 130 to store the first medical information received directly or via the first server 430 from the medical device 420. The received first medical information may be stored in the memory 130 of the mobile device 410, and at least one piece of medical information including the first medical information stored in the memory 130 may be stored in a format which may be transmitted to a second server, etc. when the user visits a different hospital.

In operation S770, the controller 120 of the mobile device 410 may control the communicator 110 to receive a request for transmitting the third medical information which is at least one piece of medical information, which is not stored in the first server 430, the third medical information being included in the second medical information of the first user, from the first server 430. That is, the third medical information is medical information of the first user, which is not stored in the first server 430, and may be included in the second medical information which is stored in the mobile device 410, in addition to the first medical information, which is the result of the examination currently performed by the medical device 420.

In operation S780, the controller 120 of the mobile device 410 may control the communicator 110 to receive first retention information from the first server 430. According to an exemplary embodiment, the first retention information may be information indicating a retention situation of the medical information of the first user stored in the first server 430, and the controller 120 of the mobile device 410 may determine medical information, which is not stored in the first server 430, based on the first retention information.

In operation S790, the controller 120 of the mobile device 410 may control the communicator 110 to transmit the first medical information of the first user to the first server 430 based on the first retention information. According to an exemplary embodiment, the controller 120 of the mobile device 410 may control the communicator 110 to select the third medical information, which is not stored in the first server 430, by comparing the first retention information with the second medical information stored in the mobile device 410, and transmit only the selected third medical information to the first server 430. According to an exemplary embodiment, before transmitting the medical information to the first server 430, a process of transmitting agreement information including whether or not to agree with the transmission of the medical information of the user of the mobile device 410, such as a patient, may further be performed. The medical information is private information of a user, and thus, an infringement of laws may occur when managing the medical information, according to whether or not the user agrees. Accordingly, the process of transmitting agreement information may become necessary. When the first server 430 receives the first medical information and the third medical information, the first medical information, which corresponds to the result of the examination that the first user currently receives, is utilized together with the previous medical information, so that it is possible to identify a change of the health condition of the first user.

Also, before or after operation S790, the controller 120 of the mobile device 410 may control the display unit (corresponding to display unit 210 of FIG. 2) to output a user interface screen notifying the third medical information transmitted to the first server 430, so that the user may recognize the third medical information that is transmitted to the first server 430.

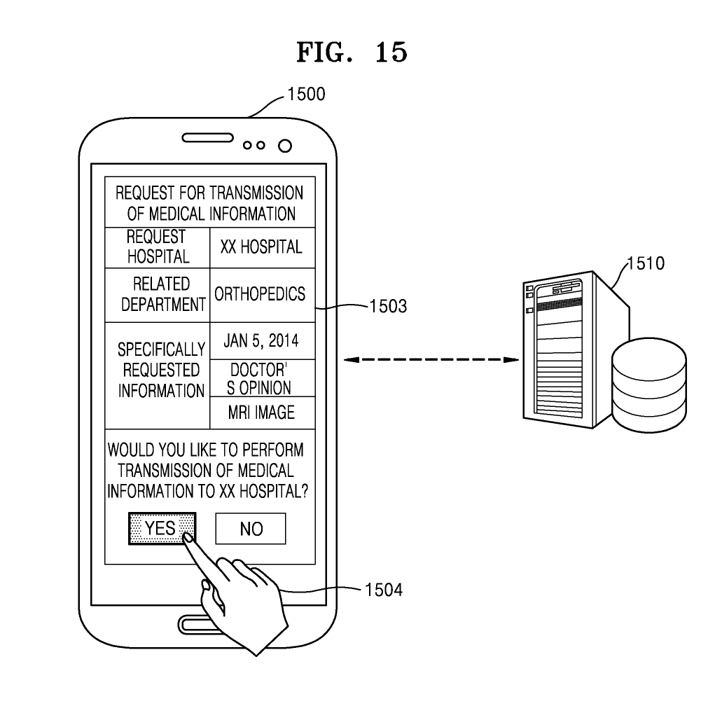

FIG. 15 is a view illustrating a process in which a mobile device 1500 receives a request for transmitting medical information, from a first server 1510, and transmits the medical information to the first server 1510, according to an exemplary embodiment. The mobile device 1500 of FIG. 15 may correspond to the mobile device 410 of FIG. 4, and the first server 1510 of FIG. 15 may correspond to the first server 430 of FIG. 4. The mobile device 1500 may transmit all or a part of the second medical information, which is medical information stored in the mobile device 1500 before the mobile device 1500 receives the first medical information, to the first server 1510. The mobile device 1500 may receive the request for transmitting the medical information from the first server 1510, and when the mobile device 1500 receives an external input 1504 for approving the request, the mobile device 1500 may transmit the medical information to the first server 1510. The mobile device 1500 may display a medical information transmission request screen 1502 on the display unit 210. The medical information transmission request screen 1502 may include a specific medical information requirement 1503 requested by the first server 1510. For example, the medical information requirement 1503 may include a hospital name, a treatment department, a period of time that is requested, a requested item, etc.

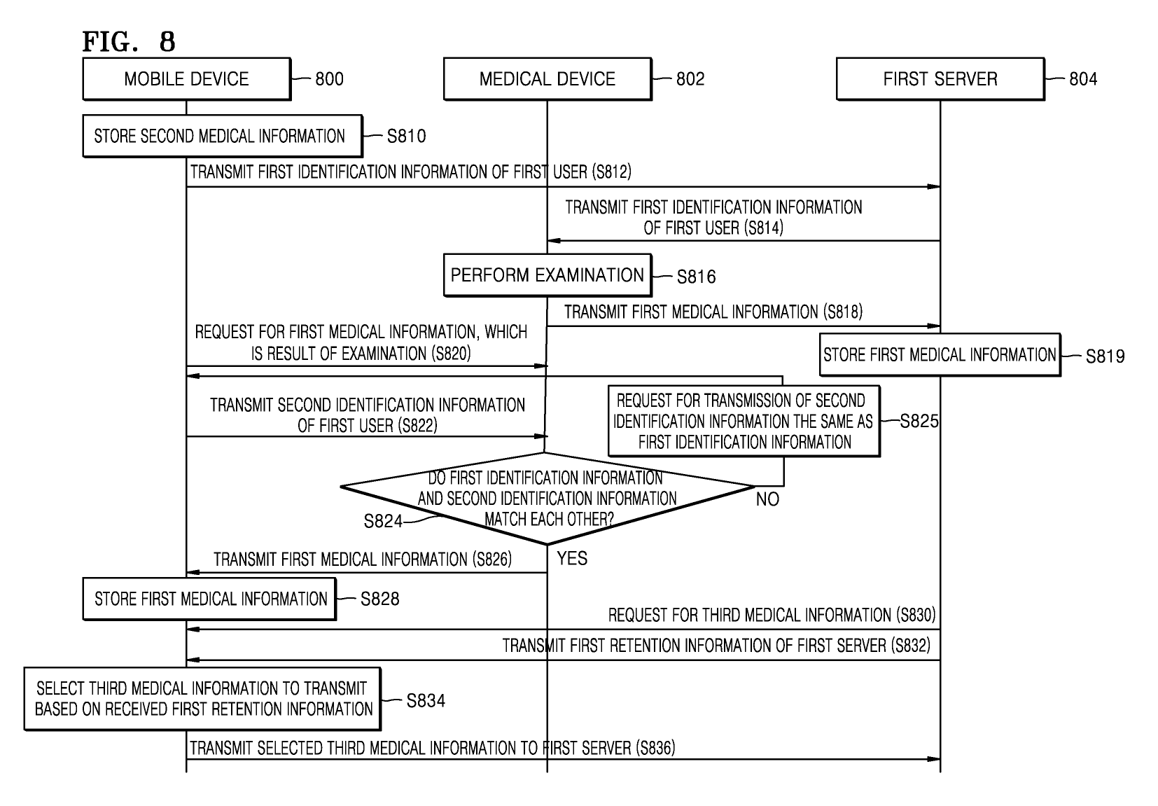

FIG. 8 is a flowchart of a method of processing and storing personal medical information among a mobile device 800, a medical device 802, and a first server 804. In detail, FIG. 8 illustrates a flow of information among the mobile device 800, the medical device 802, and the first server 804, as the flowchart of the method of storing received first medical information in the mobile device 800 and transmitting to the first server 804 third medical information, which is not stored in the first server 804 but is stored in the mobile device 800, based on first retention information. The mobile device 800 may correspond to the mobile device 410 of FIG. 4, the medical device 802 may correspond to the medical device 420 of FIG. 4, and the first server 804 may correspond to the first server 430 of FIG. 4.

In operation S810, the mobile device 800 may store the second medical information. Detailed aspects with respect thereto may correspond to operation S710 of FIG. 7, and thus, their descriptions will be omitted.

In operation S812, the mobile device 800 may control the communicator 110 to transmit first identification information of a first user to the first server 804. Detailed aspects with respect thereto may correspond to operation S720 of FIG. 7, and thus, their descriptions will be omitted.

In operation S814, the first server 804 which received the first identification information may transmit the received first identification information to the medical device 802. Detailed aspects with respect thereto may correspond to operation S720 of FIG. 7, and thus, their descriptions will be omitted.

In operation S816, the controller 320 of the medical device 802 which received the first identification information may control the medical device 802 to perform an examination of the first user corresponding to the first identification information.

In operation S818, the controller 320 of the medical device 802 may control the communicator 310 to transmit first medical information, which is a result of the examination performed in operation S816, to the first server 804. Detailed aspects with respect thereto may correspond to operation S740 of FIG. 7, in which the medical device 420 transmits the first medical information to the first server 430, and thus, their descriptions will be omitted.

In operation S819, the first server 804 may receive the first medical information from the medical device 802 and store the first medical information.

In operation S820, the controller 120 of the mobile device 800 may control the communicator 110 to request the medical device 802 to transmit the first medical information. Detailed aspects with respect thereto may correspond to operation S730 of FIG. 7, and thus, their descriptions will be omitted.

In operation S822, the controller 120 of the mobile device 800 may control the communicator 110 to transmit the second identification information of the first user to the medical device 802. Detailed aspects with respect thereto may correspond to operation S740 of FIG. 7, in which the mobile device 410 transmits the second identification information to the medical device 420, and thus, their descriptions will be omitted.

In operation S824, the controller 320 of the medical device 802 may control the medical device 802 to check whether the first identification information received from the first server 804 and the second identification information received from the mobile device 800 correspond to each other. This is an authentication process for transmitting the first medical information, which is the result of the examination of the first user, to the same first user, by matching the first identification information with the second identification information, before transmitting the first medical information to the mobile device 800. Detailed aspects with respect thereto may correspond to operation S750 of FIG. 7, and thus, their descriptions will be omitted. According to an exemplary embodiment, when the first identification information and the second identification information do not correspond to each other, the controller 320 of the medical device 802 may control the communicator 310 to request the mobile device 800 to transmit the second identification information corresponding to the first identification information. Accordingly, the mobile device 800 may transmit the second identification information which is the same as the first identification information to the medical device 802, by going through operation S822 again. According to an exemplary embodiment, if the first identification information and the second identification information correspond to each other, the controller 320 of the medical device 802 may control the communicator 310 to transmit the first medical information to the mobile device 800, in operation S826.

In operation S828, the controller 120 of the mobile device 800 may control the memory 130 to store the received first medical information, when the mobile device 800 receives the first medical information as the first identification information and the second identification information received by the medical device 802 correspond to each other. Detailed aspects with respect thereto may correspond to operation S760 of FIG. 7, and thus, their descriptions will be omitted.

In operation S830, the first server 804 may request the mobile device 800 to transmit the third medical information which is at least one piece of medical information, which is not stored in the first server, the third medical information being included in second medical information of the first user, which is stored in the mobile device 800. Detailed aspects with respect thereto may correspond to operation S770 of FIG. 7, and thus, their descriptions will be omitted.

In operation S832, the first server 804 may transmit first retention information indicating a medical information retention situation of the first server 804 to the mobile device 800. The mobile device 800 may refer to the second medical information and the received first retention information to select the third medical information that is to be transmitted to the first server 804. Detailed aspects with respect thereto may correspond to operation S780 of FIG. 7, and thus, their descriptions will be omitted.

In operation S834, the mobile device 800 may select the third medical information that is to be transmitted to the first server 804, based on the first retention information received from the first server 804 in operation S832. According to an exemplary embodiment, the third medical information that is to be transmitted to the first server 804 may be selected by comparing the first retention information with the second medical information stored in the mobile device 800.

In operation S836, the controller 120 of the mobile device 800 may control the communicator 110 to transmit the third medical information selected in operation S834 to the first server 804. Detailed aspects with respect thereto may correspond to operation S790 of FIG. 7, and thus, their descriptions will be omitted.

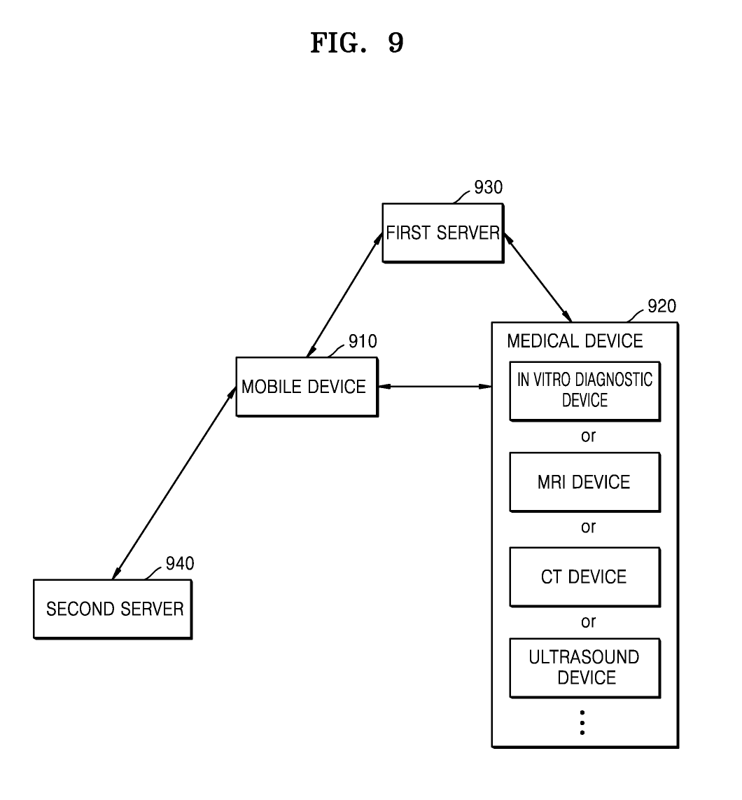

FIG. 9 is a view for describing a flow of information among a mobile device 910, a medical device 920, a first server 930, and a second server 940, according to an exemplary embodiment. The mobile device 910 may correspond to the mobile device 410 of FIG. 4, the medical device 920 may correspond to the medical device 420 of FIG. 4, and the first server 930 may correspond to the first server 430 of FIG. 4. The second server 940 may be a different server from the first server 930, and may be a server corresponding to a hospital different from the hospital corresponding to the first server 930.

According to an exemplary embodiment, the mobile device 910 may already store second medical information which was received from the second server 940, in the memory 130, before receiving first medical information from the first server 930. For example, the second medical information may be medical information corresponding to a result of an examination performed before the first medical information of a user is received. When the result of the examination performed before an examination which is performed after the first server 930 is accessed is not stored in the first server 930, the mobile device 910 may transmit the second medical information to the first server 930. Since an analysis of a patient's health condition or a disease recovery condition, by using previous medical information, is essential for diagnosing the patient, previous medical records or treatment records may be necessary. For the user of the mobile device 910, the user may integrate and manage his medical information in the mobile device 910, and thus, the user may transmit the second medical information which is the previous medical information stored in the mobile device 910 to the first server 930, which is a server of the hospital that he currently visits.

According to an exemplary embodiment, the second medical information may be medical information which is received from the second server 940 or a medical device connected with the second server 940, and stored in the memory 130, as the result of the examination performed by accessing the second server 940 corresponding to a hospital that the user previously visited. Since the second medical information is received from an external server or a device, which is different from the first server 930 or the medical device 920 connected with the first server 930, the second medical information may be the medical information generated by using a different standard from the standard used by the first server 930 or the medical device 920. For example, the first server 930 may undergo a process of generating and processing a medical image and message by using the standards, such as a picture archiving and communication system (PACS), digital imaging and communication in medicine (DICOM), or health level 7 (HL7). For the mobile device 910 to transmit the second medical information to the first server 930 so that the first server 930 uses the received second medical information, the data related to the medical information, such as the medical image or the transmitted and received message, should be in a format which can be used in an application operating in the first server 930. For example, the data related to the medical information should include a parameter meeting the standards or correspond to a data format having the same extension. The memory 130 of the mobile device 910 may receive the second medical information from the second server 940 or the medical device connected with the second server 940 and store the second medical information, and the controller 120 may perform a process of converting the second medical information into a format which can be used in the first server 930 as described above, before transmitting the second medical information to the first server 930. The data converted into the format which can be used in the first server 930 may be transmitted to the first server 930 by using the communicator 110.

According to an exemplary embodiment, the mobile device 910 may receive a request for transmitting the second medical information from the first server 930, and may receive standards information including the standards used by the first server 930 to manage the medical image information. The mobile device 910 which received the standards information of the first server 930 may convert the second medical information that is to be transmitted to the first server 930 into an appropriate format which can used in the first server 930, based on the standards information. In detail, the standards information may include the standards used by the first server 930 to manage the medical information, and a parameter used in the standards. According to another exemplary embodiment, the mobile device 910 may receive first retention information indicating medical information retained in the first server 930 and determine third medical information which is medical information that is not retained in the first server 930 from among the second medical information. Also, the mobile device 910 may receive the standards information including the standards used by the first server 930 to manage the medical image information. Accordingly, the mobile device 910 may determine the third medical information that is to be transmitted to the first server 930, based on the first retention information, and may convert the third medical information that is to be transmitted to the first server 930 into a format which can be used in the first server 930, based on the received standards information.

According to an exemplary embodiment, the exchange of the medical information between the mobile device 910 and the second server 940 may correspond to the transmission and reception of the first medical information corresponding to the result of the examination that the first user of the mobile device 910 received in the hospital corresponding to the first server 930, and fourth medical information which is medical information, which is not stored in the second server 940. Detailed aspects with respect thereto will be described below by referring to an exemplary embodiment.

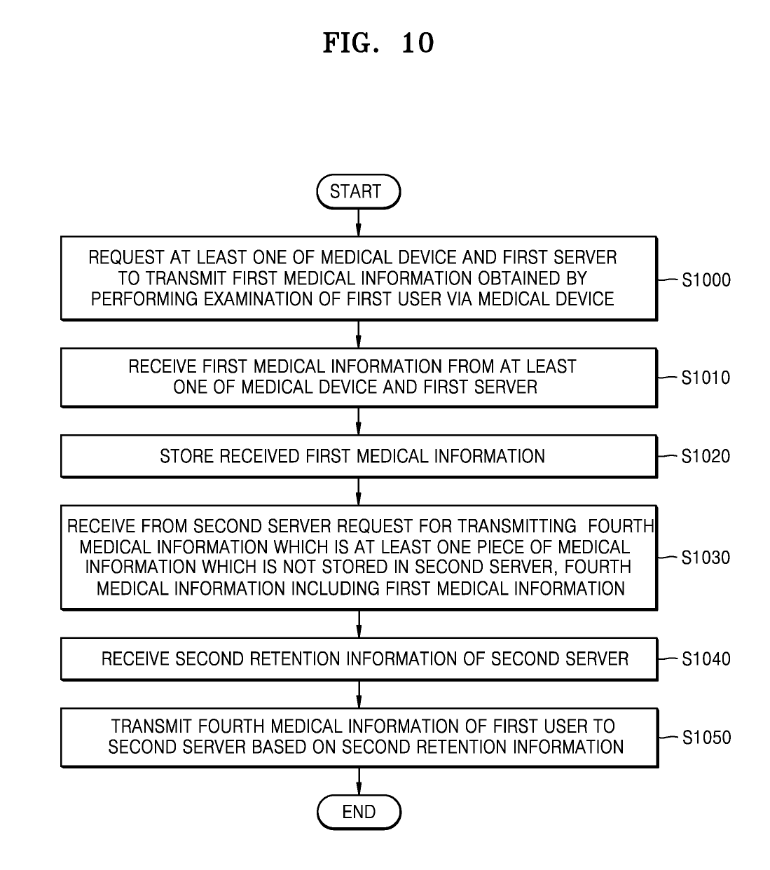

FIG. 10 is a flowchart of a method of processing and storing personal medical information, according to another exemplary embodiment. FIG. 10 is the flowchart of the method of receiving second retention information from the second server 940, and transmitting the fourth medical information which is at least one piece of medical information, which is not stored in the second server 940, to the second server, based on the second retention information.

In operation S1000, the controller 120 of the mobile device 910 may control the communicator 110 to request at least one of the medical device 920 and the first server 930 to transmit the first medical information obtained by performing the examination of the first user via the medical device 920. The first medical information is medical information which may correspond to the result of the examination performed for the first user by the medical device 920. Detailed aspects with respect thereto may correspond to operation S510 of FIG. 5, and thus, their descriptions will be omitted.

In operation S1010, the controller 120 of the mobile device 910 may control the communicator 110 to receive the first medical information from at least one of the medical device 920 and the first server 930. Detailed aspects with respect thereto may correspond to operation S520 of FIG. 5, and thus, their descriptions will be omitted.

In operation S1020, the controller 120 of the mobile device 910 may control the memory 130 to store the first medical information received in operation S1010. According to an exemplary embodiment, the first medical information may be stored in the memory 130 of the mobile device 910, and at least one piece of medical information, which includes the first medical information stored in the memory 130, may be stored in a format which can be transmitted to the second server, etc., when a second server corresponding to another hospital has to receive the first medical information, as patient visits the other hospital. For example, when predetermined data is exchanged among servers of hospitals, according to the DICOM standards, which is the standards for data transmission or reception, the first medical information may be generated and stored in a format according to the standards, such as DICOM, PACS, electronic medical record (EMR), personal health record (PHR), radiology information system (RIS), HL7, etc. However, the standards for the hospital medical system and the medical information according to exemplary embodiments are not limited thereto, and any standard according to which medical information can be exchanged and processed between a hospital system and a mobile device may be used.

In operation S1030, the controller 120 of the mobile device 910 may control the communicator 110 to receive from the second server 940 a request for transmitting the fourth medical information which is at least one piece of medical information, which is not stored in the second server 940, the fourth medical information including the first medical information. The first server 930 and the second server 940 may retain different medical information. Also, since medical information of the first server 930 and the second server 940 are not shared, the first server 930 and the second server 940 may store different medical information. Accordingly, the medical information stored in the first server 930 may include medical information, which is not stored in the second server 940, and the medical information stored in the second server 940 may include medical information, which is not stored in the first server 930. According to an exemplary embodiment, at least one piece of medical information, which is not stored in the first server 930, and at least one piece of medical information, which is not stored in the second server 940, may be stored in the mobile device 910. The third medical information which is at least one piece of medical information, which is not stored in the first server 930 but is stored in the mobile device 910, may be transmitted to the first server 930 from the mobile device 910. Detailed aspects with respect thereto may correspond to operations S770 through S790 of FIG. 7, and thus, their descriptions will be omitted. After the mobile device 910 receives the first medical information from the medical device 920 and stores the first medical information, the second server 940 may request mobile device 920 to transmit the fourth medical information which is at least one piece of medical information, which is not stored in the second server 940. Since the fourth medical information denotes medical information, which is not stored in the second server 940, the first medical information may be included in the fourth medical information.

In operation S1040, the controller 120 of the mobile device 910 may control the communicator 110 to receive the second retention information from the second server 940. According to an exemplary embodiment, the second retention information may indicate a medical information retention situation of the second server.

In operation S1050, the controller 120 of the mobile device 910 may control the communicator 110 to transmit the fourth medical information with respect to the first user to the second server 940, based on the second retention information received from the second server 940 in operation S1040. According to an exemplary embodiment, the controller 120 of the mobile device 910 may select the medical information, which is not stored in the second server 940, by comparing the received second retention information with the first and second medical information as the medical information currently stored in the mobile device 910. The controller 120 of the mobile device 910 may control the communicator 110 to select the medical information, which is not stored in the second server 940, and transmit the selected medical information to the second server 940.

Also, the data to be transmitted to the second server 940 from the mobile device 910 may be manually selected by the user. For example, the controller 120 of the mobile device 910 may compare the first medical information and the second medical information, and control a user interface screen to be output, which includes a list of medical information not stored in the second server 940. Then, the user may select predetermined information to be transmitted to the second server 940 from the list showed on the user interface screen. Further, the controller may control the communicator 110 to transmit the predetermined information selected by the user to the second server 940.

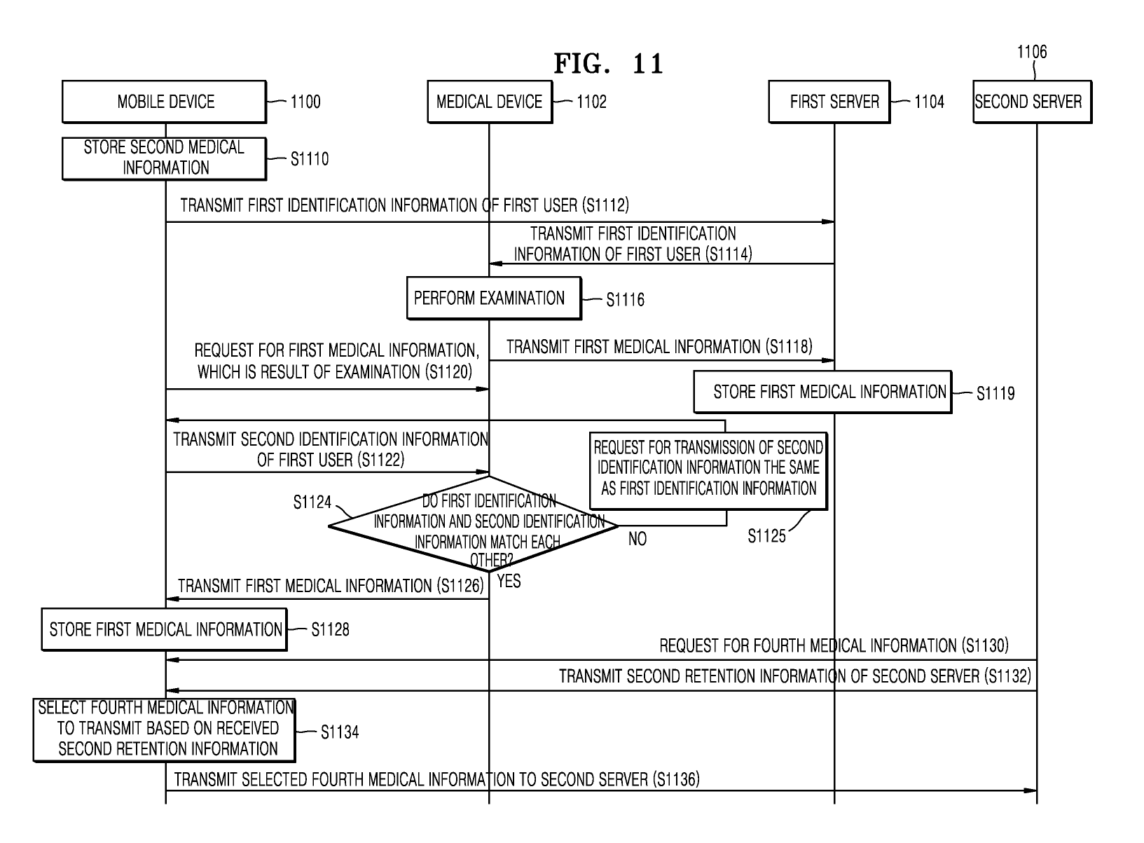

FIG. 11 is a flowchart of a method of processing and storing personal medical information among a mobile device 1100, a medical device 1102, and a first server 1104, according to another exemplary embodiment. FIG. 11 illustrates a flow of information among the mobile device 1100, the medical device 1102, the first server 1104, and the second server 1106, as the flowchart of the method of receiving second retention information from the second server 1106, and transmitting fourth medical information which is at least one piece of medical information, which is not stored in the second server 1106, to the second server 1106 based on the second retention information, via the mobile device 1100. The mobile device 1100 may correspond to the mobile device 910 of FIG. 9, the medical device 1102 may correspond to the medical device 920 of FIG. 9, the first server 1104 may correspond to the first server 930 of FIG. 9, and the second server 1106, may correspond to the first server 940 of FIG. 9.

In operation S1110, the controller 120 of the mobile device 1110 may control the memory 130 to store second medical information. The second medical information is medical information which is already stored in the mobile device 1100, when the mobile device 1100 receives and stores first medical information. Detailed aspects with respect thereto may correspond to operation S810 of FIG. 8, and thus, their descriptions will be omitted.

In operation S1112, the mobile device 1110 may control the communicator 110 to transmit first identification information of a first user to the first server 1104. Detailed aspects with respect thereto may correspond to operation S812 of FIG. 8, and thus, their descriptions will be omitted.

In operation S1114, the first server 1104 which received the first identification information may transmit the received first identification information to the medical device 1102. Detailed aspects with respect thereto may correspond to operation S814 of FIG. 8, and thus, their descriptions will be omitted.

In operation S1116, the medical device 1102 which received the first identification information performs an examination of the first user corresponding to the first identification information.

In operation S1118, the medical device 1102 transmits first medical information, which is a result of the examination performed in operation S1116, to the first server 1104. Detailed aspects with respect thereto may correspond to operation S818 of FIG. 8, and thus, their descriptions will be omitted.

In operation S1119, the first server 1104 may receive the first medical information from the medical device 1102 and store the received first medical information.

In operation S1120, the controller 120 of the mobile device 1100 may control the communicator 110 to request the medical device 1102 to transmit the first medical information. Detailed aspects with respect thereto may correspond to operation S820 of FIG. 8, and thus, their descriptions will be omitted.

In operation S1122, the controller 120 of the mobile device 1100 may control the communicator 110 to transmit second identification information of the first user to the medical device 1102. Detailed aspects with respect thereto may correspond to operation S822 of FIG. 8, and thus, their descriptions will be omitted.

In operation S1124, the medical device 1102 may identify whether the first identification information received from the first server 1104 and the second identification information received from the mobile device 800 correspond to each other. Detailed aspects with respect thereto may correspond to operation S824 of FIG. 8, and thus, their descriptions will be omitted.

According to an exemplary embodiment, when the first identification information and the second identification information do not correspond to each other, the controller 320 of mobile device 1102 may control the communicator 310 to request the mobile device 1100 to transmit the second identification information which is the same as the first identification information, in operation S1125. Accordingly, the mobile device 1100 may transmit the second identification information which is the same as the first identification information to the medical device 802, by going through operation S1122 again.

According to an exemplary embodiment, if the first identification information and the second identification information correspond to each other, the controller 320 of the medical device 1102 may control the communicator 310 to transmit the first medical information to the mobile device 1100, in operation S1126.

In operation S1128, the controller 120 of the mobile device 1100 may control the memory 130 to store the received first medical information, when the mobile device 1100 receives the first medical information as the first identification information and the second identification information received by the medical device 1102 correspond to each other. At least one piece of medical information, which includes the first medical information stored in the memory 130, may be stored in a format which can be transmitted to the second server 1106 when the user visits another hospital.

In operation S1130, the controller 120 of the mobile device 1100 may control the communicator 110 to receive a request for transmitting the fourth medical information from the second server 1106. The fourth medical information refers to at least one piece of medical information, which is not stored in the second server 1106, and the fourth medical information may include the first medical information. Detailed aspects with respect thereto may correspond to operation S1030 of FIG. 10, and thus, their descriptions will be omitted.

In operation S1132, the controller 120 of the mobile device 1100 may control the communicator 110 to receive the second retention information from the second server 1106. The second retention information may be information indicating a retention situation of the medical information of the first user stored in the second server 1106, and the mobile device 1100 may determine medical information, which is not stored in the second server 1106, based on the second retention information. The mobile device 1100 may refer to the first and second medical information and the received second retention information to select the fourth medical information that is to be transmitted to the second server 1106.

In operation S1134, the controller 120 of the mobile device 1100 may select the fourth medical information that is to be transmitted to the second server 1106, based on the second retention information received in operation S1132. According to an exemplary embodiment, the mobile device 1100 may select the fourth medical information that is to be transmitted to the second server 1106, by comparing the second retention information indicating the medical information retention situation of the second server 1106 with the first medical information and the second medical information stored in the mobile device 110.

In operation S1136, the controller 120 of the mobile device 1100 may control the communicator 110 to transmit the fourth medical information selected in operation S1134 to the second server 1106. When the second server 1106 receives the fourth medical information, the hospital corresponding to the second server 1106 may store the fourth medical information which includes the examination result of another hospital, and a diagnosis for the first user may be performed based on this.

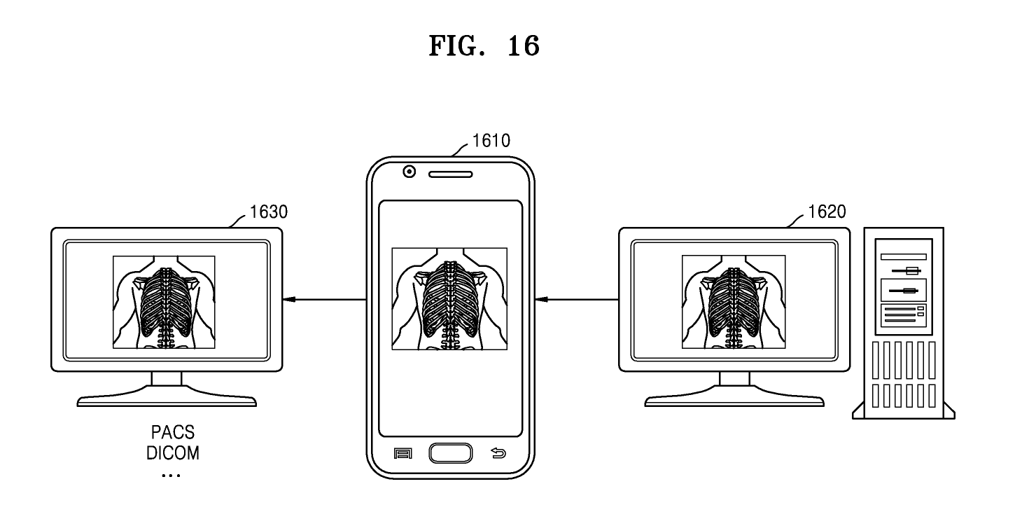

FIG. 16 is a view illustrating a process in which a mobile device 1610 receives first medical information from a first server 1620 and transmits to a second server 1630 corrected first medical information which is generated by performing an inter-compatibility process on the first medical information, according to an exemplary embodiment. The mobile device 1610 may correspond to the mobile device 910 of FIG. 9, the first server 1620 may correspond to the first server 930 of FIG. 9, and the second server 1630 of FIG. 16 may correspond to the second server 940 of FIG. 9. A medical image photographed by a medical device may be managed via the first server 1620 or the second server 1630. According to an exemplary embodiment, the medical image file generated by the medical device may be in a format corresponding to the DICOM standards, and if the first server 1620 or the second server 1630 is capable of using the image format corresponding to the DICOM standards, the first server 1620 or the second server 1630 may use the medical image corresponding to the DICOM standards, which is transmitted from the medical device. However, if first medical information received from the first server 1620 is not in the image format corresponding to the DICOM standards but is in another image format which is not supported by the second server 1630 to which the first medical information is to be transmitted, the second server 1630 may not use the first medical information even if the second server 1630 receives the first medical information. Thus, when the first medical information is not inter-compatible with the second server 1630, the mobile device 1610 may perform an inter-compatibility process by which the first medical information is converted into a format which is compatible with the second server 1630, to generate the corrected first medical information which can be used in the second server 1630. According to exemplary embodiments, the DICOM standards may include not only image information but also various data, such as patient data (a patient's name, gender, and ID), imaging modality, and imaging process information (a radiation amount, a contrast medium, a device parameter, etc.), and thus, the medical information of a simple image file cannot be seen as compatible with the DICOM standards. Thus, when the mobile device 1610 receives the first medical information corresponding to the simple medical image file from the first server 1620, the second server 1630 using the DICOM standards may not use the first medical information in its original format, and thus, the mobile device 1610 may perform the inter-compatibility process before transmitting the first medical information to the second server 1630. For example, when the mobile device 1610 additionally receives files corresponding to a medical image, patient data, investigation content, etc with respect to the first medical information, from the first server 1620, the mobile device 1610 may generate the corrected first medical information by recognizing the files corresponding to the patient data, imaging modality, and imaging process information, with respect to the first medical information, and converting the files into a format compatible with the DICOM standards, before transmitting the first medical information to the second server 1630.

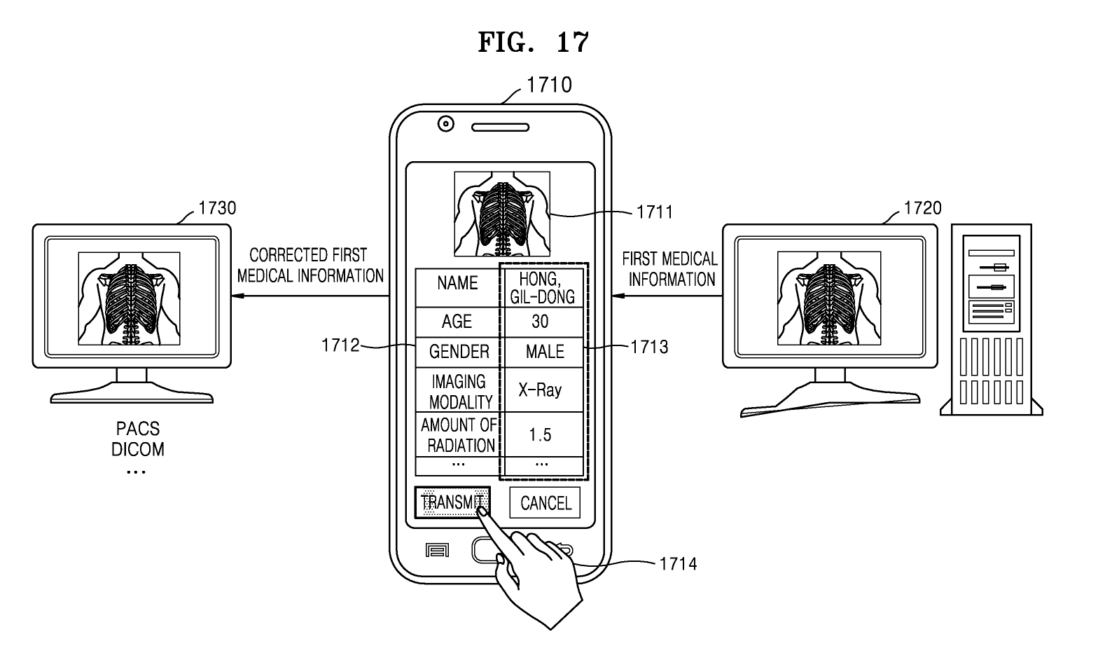

FIG. 17 is a view illustrating a process in which information for an inter-compatibility process is input, when a mobile device 1710 receives first medical information from a first server 1720 and transmits to a second server 1730 corrected first medical information which is generated by performing the inter-compatibility process on the first medical information, according to an exemplary embodiment. The mobile device 1710 may correspond to the mobile device 910 of FIG. 9, the first server 1720 may correspond to the first server 930 of FIG. 9, and the second server 1730 of FIG. 17 may correspond to the second server 940 of FIG. 9. In detail, according to an exemplary embodiment, the medical image file generated by the medical device may be in a format corresponding to the DICOM standards, and if the first server 1720 or the second server 1730 is capable of using the image format corresponding to the DICOM standards, the first server 1720 or the second server 1730 may use the medical image corresponding to the DICOM standards, which is transmitted from the medical device. However, if first medical information received from the first server 1720 is not in the image format corresponding to the DICOM standards but is in another image format which is not supported by the second server 1730 to which the first medical information is to be transmitted, the second server 1730 may not use the first medical information even if the second server 1730 receives the first medical information. In this case, the mobile device 1710 may generate the corrected first medical information by performing an inter-compatibility process on the first medical information such that the first medical information is converted into a format which can be used in the second server 1730. Further, the mobile device 1710 may generate the corrected first medical information based on the first medical information and the standards information that is input. For example, the DICOM standards may include not only image information but also various data, such as patient data (a patient's name, gender, and ID), imaging modality, and imaging process information (a radiation amount, a contrast medium, a device parameter, etc.). In this case, when the mobile device 1710 receives only the medical image from the first server 1720, the mobile device 1710 may perform the inter-compatibility process based on the standards information that is received via the user input unit 245 so that the second server 1730 using the DICOM standards can use the medical image. The mobile device 1710 may display an information window 1712 related to the standards information which includes a patient's name and gender, imaging modality, an amount of radiation, etc., before transmitting the first medical information 1711 received from the first server 1720 to the second server 1730. In this case, the information window 1712 may include an input space 1713 in which parameter information necessary for the DICOM standards may be input. When the mobile device 1710 receives the standards information related to the first medical information 1711 via the user input unit 245, and a touch signal 1714 for a transmission button portion, the mobile device 1710 may perform the inter-compatibility process to generate the corrected first medical information, and may transmit the corrected first medical information to the second server 1730. Further, according to an exemplary embodiment, the mobile device 1710 may receive information related to a medical information management system or the standards currently used by the second server 1730, from the second server 1730. By determining and displaying the standards information that is to be input by the user, based on the received information, the mobile device 1710 may receive the standards information necessary for the inter-compatibility process for the first medical information.

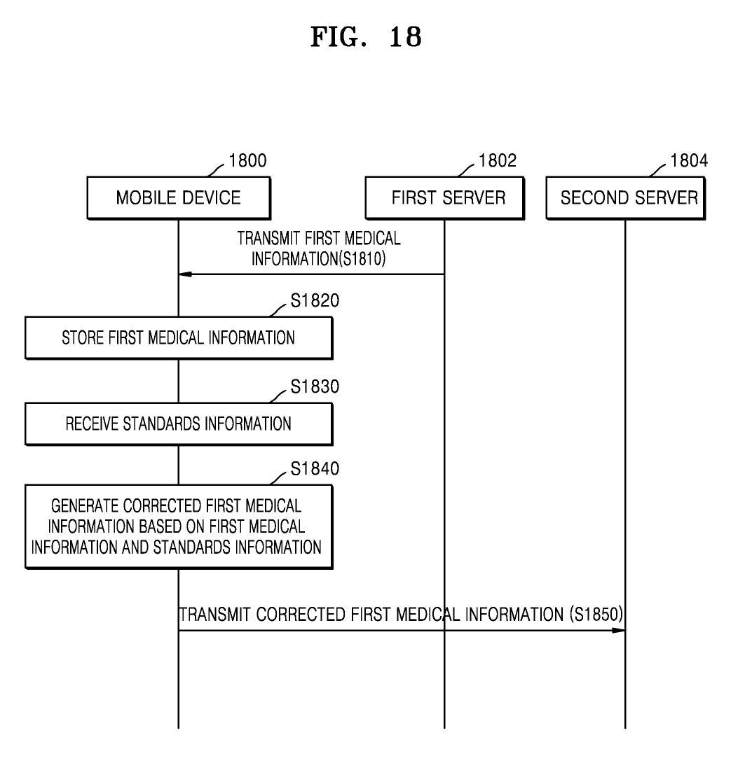

FIG. 18 is a flowchart of a process of performing an inter-compatibility process on first medical information stored in a mobile device 1800 and transmitting the first medical information to a second server 1804, according to an exemplary embodiment. The mobile device 1800 may correspond to the mobile device 910 of FIG. 9, a first server 1802 may correspond to the first server 930 of FIG. 9, and the second server 1804 of FIG. 18 may correspond to the second server 940 of FIG. 9.

In operation S1810, the mobile device 1800 may receive the first medical information from the first server 1802. It will be understood by referring to the above-described exemplary embodiments that the first medical information may be transmitted not only from the first server 1802, but also from a first medical device related to the first server 1802. However, for convenience of explanation, it will be assumed that the first medical information is received from the first server 1802.

In operation S1820, the mobile device 1800 may store the first medical information received in operation S1810 in the memory 130. At least one piece of medical information, which includes the first medical information stored in the memory 130, may be stored in a format which can be transmitted to another server, i.e., the second server 1804, when a user visits another hospital. However, due to a difference of the medical information management system and the standards, the first medical information may be stored in a format which cannot be directly transmitted to the second server 1804.

In operation S1830, the mobile device 1800 may receive the standards information via the user input unit 245. In detail, if the first medical information received from the first server 1802 is in a format which does not correspond to the medical information management system or the standards used by the second server 1804, the second server 1804 may not use the first medical information, even if the second server 1804 receives the first medical information. For example, if the first medical information received from the first server 1820 is not in the image format corresponding to the DICOM standards but is in another image format which is not supported by the second server 1804 to which the first medical information is to be transmitted, the second server 1804 may not use the first medical information even if the second server 1840 receives the first medical information. Thus, the mobile device 1800 may require an appropriate inter-compatibility process for the first medical information, before transmitting the first medical information to the second server 1804, and the mobile device 1800 may receive the standards information which is information necessary for the inter-compatibility process. For receiving the standards information, the mobile device 1800 may display the information window 1712 related to the standards information which includes a patient's name and gender, imaging modality, an amount of radiation, etc., and the input space 1713 in which parameter information necessary for the DICOM standards may be input. Further, according to an exemplary embodiment, the mobile device 1800 may receive information related to a medical information management system or the standards currently used by the second server 1840, from the second server 1840. By determining and displaying the standards information that is to be input by the user, based on the received information, the mobile device 1800 may receive the standards information necessary for the inter-compatibility process for the first medical information.

In operation S1840, the mobile device 1800 may generate the corrected first medical information based on the first medical information stored in operation S1820 and the standards information received in operation S1830. The corrected first medical information includes the first medical information that is received from the first server 1802 and stored in the mobile device 1800, and has a format which is compatible with the standards or the medical information management system used by the second server 1804.

In operation S1850, the mobile device 1800 may transmit the corrected first medical information generated in operation S1840 to the second server 1804. The user of the mobile device 1800 may transmit the first medical information received from the first server 1802 to the second server 1804, when he visits another hospital corresponding to the second server 1804, which is different from a hospital corresponding to the first server 1802. According the exemplary embodiment, the user using the mobile device 1800 which may generate the corrected first medical information by performing the inter-compatibility process on the first medical information, may visit different hospitals, regardless of whether the medical information standards among the hospitals match one another or whether the medical information management systems among the hospitals are compatible with one another.

According to an exemplary embodiment, the mobile device 1800 may use user authentication information that is input via a finger scan sensor included in the user input unit 245, in order to transmit the first identification information and the second identification information. The user authentication information may be information for sensing whether the user is a subject corresponding to the first medical information before the mobile device 1800 transmits the first medical information. When it is determined that the user is the subject corresponding to the first medical information, based on the user authentication information received via the finger scan sensor, the mobile device 1800 may transmit the first identification information or the second identification information to the first server 1802 or the second server 1804. According to an exemplary embodiment, the mobile device 1800 may automatically generate the first identification information or the second identification information based on the user authentication information received via the finger scan sensor. The first identification information or the second identification information which is automatically generated may be information corresponding to the user authentication information received via the finger scan sensor.

As described above, according to the one or more of the above exemplary embodiments, a medical device, a hospital information system, and a personal mobile device are connected with one another so that personal medical information is stored in the personal mobile device and the data stored in the mobile device is transmitted to the hospital information system whenever necessary. Accordingly, when a user visits different hospitals, previous medical information can be identified and used for a diagnosis. Therefore, according to exemplary embodiments, individual's previous medical information may be easily utilized later, and also, the privacy policy may be better protected since personal medical information is stored and used in a personal mobile device.

Exemplary embodiments may be embodied as computer-readable codes in a computer-readable recording medium. The computer-readable recording medium may be any recording apparatus capable of storing data that is read by a computer system.

The computer-readable codes perform operations forming a method of distributing an object, when the computer-readable codes are read from the computer-readable recording medium and executed by a processor. The computer-readable codes may be realized as various programming languages. Functional programs, codes, and code segments for embodying exemplary embodiments may be easily derived by those skilled in the technical field to which exemplary embodiments pertain.

Examples of the computer-readable recording medium include read-only memories (ROMs), random-access memories (RAMs), CD-ROMs, magnetic tapes, floppy disks, and optical data storage devices. The computer readable medium may be distributed among computer systems that are interconnected through a network, and the exemplary embodiments may be stored and implemented as computer readable codes in the distributed system.

It should be understood that exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

What is claimed is:

1. A mobile device which is managed by a subject of a medical examination, the mobile device comprising:
a communicator configured to receive first medical information that is obtained by performing an examination of a first user, from at least one of a first medical device and a first server;
a memory configured to store the first medical information; and
a controller configured to control the communicator to generate corrected first medical information by performing an inter-compatibility process on the first medical information, wherein the inter-compatibility process causes the corrected first medical information to be usable in a second medical device or a second server which is different from the first medical device or the first server, and transmit the corrected first medical information to at least one of the second medical device or the second server.

2. The mobile device of claim 1, wherein the controller is configure to control the communicator to transmit first identification information of the first user to the first server.

3. The mobile device of claim 2, wherein the controller is configured to control the communicator to transmit second identification information of the first user to at least one of the first medical device and the first server, and
the communicator is configured to receive the first medical information from the first medical device if the first identification information and the second identification information correspond to each other.

4. The mobile device of claim 1, wherein the memory is configured to store second medical information corresponding to a result of a previously performed examination of the first user.

5. The mobile device of claim 4, wherein the controller is configured to control the communicator to receive from the first server a request for transmitting third medical information which is at least one piece of medical information, which is not stored in the first server, the third medical information being included in the second medical information, and transmit the third medical information to the first server.

6. The mobile device of claim 5, wherein the controller is configured to select the third medical information from the second medical information, based on first retention information received from the first server, wherein the retention information indicates a medical information retention situation of the first server.

7. The mobile device of claim 4, wherein the controller is configured to
control the communicator to receive from the second server a request for transmitting fourth medical information, the fourth medical information being at least one piece of medical information which is not stored in the second server, the fourth medical information including the first medical information;
receive second retention information indicating a medical information retention situation of the second server from the second server;
select the fourth medical information to be transmitted to the second server based on the received second retention information;
and transmit the fourth medical information to the second server.

8. The mobile device of claim 1, wherein the communicator is configured to transmit or receive data by using at least one of Bluetooth, radio frequency identification (RFID), barcode, QRcode, near field communication (NFC), Wi-Fi direct (WFD), ultra wideband (UWB), ZigBee, and Ant+.

9. The mobile device of claim 1, wherein the controller is configured to control the communicator to transmit network information of the mobile device to at least one of the first medical device and the first server, and receive the first medical information based on the network information.

10. A medical device which manages personal medical information, the medical device comprising:
a controller configured to control the medical device to perform an examination of a first user, and transmit first medical information, which is a result of the examination, to at least one of a mobile device and a first server, in response to receiving a request for transmitting the first medical information from the at least one of the mobile device and the first server, and
a communicator configured to transmit the first medical information to at least one of the mobile device and the first server.

11. The medical device of claim 10, wherein the communicator is configured to receive first identification information of the first user from at least one of the mobile device and the first server, and
in response to receiving the first identification information, the controller is configured to perform the examination in correspondence to the first identification information.

12. The medical device of claim 11, wherein the communicator is configured to receive second identification information of the first user from the at least one of the mobile device and the first server, and
if the first identification information and the second identification information correspond to each other, the controller is configured to control the communicator to transmit the first medical information to the mobile device.

13. The medical device of claim 10, wherein the communicator is configured to transmit or receive data by using at least one of Bluetooth, radio frequency identification (RFID), barcode, QRcode, near field communication (NFC), Wi-Fi direct (WFD), ultra wideband (UWB), ZigBee, and Ant+.

14. A method of managing personal medical information via a mobile device, the method comprising:
sending a request for first medical information obtained by performing an examination of a first user via a first medical device, to at least one of the first medical device and a first server;
receiving the first medical information from at least one of the first medical device and the first server;
storing the first medical information;
generating corrected first medical information by performing an inter-compatibility process on the first medical information, wherein the inter-compatibility process causes the first medical information to be usable in a second medical device or a second server which is different from the first medical device or the first server; and
transmitting the corrected first medical information to at least one of the second medical device and the second server.

15. The method of claim 14, further comprising transmitting first identification information of the first user to the first server, and
wherein the receiving of the first medical information comprises:
transmitting second identification information of the first user to the first medical device and the first server; and
receiving the first medical information from the first medical device if the first identification information and the second identification information correspond to each other.

16. The method of claim 15, further comprising storing second medical information corresponding to a result of the examination of the first user.

17. The method of claim 16, further comprising:
receiving from the first server a request for transmitting third medical information which is at least one piece of medical information, which is not stored in the first server, the third medical information being included in the second medical information of the first user; and
transmitting the third medical information to the first server.

18. The method of claim 17, wherein the transmitting of the third medical information further comprises:
receiving first retention information indicating a medical information retention situation of the first server from the server; and
selecting the third medical information that is to be transmitted, based on the first retention information.

19. The method of claim 14, further comprising:
receiving from the second server a request for transmitting fourth medical information, the fourth medical information being one piece of medical information which is not stored in the second server, the fourth medical information including the first medical information;
receiving second retention information indicating a medical information retention situation of the second server from the second server;
selecting the fourth medical information that is to be transmitted, based on the received second retention information; and
transmitting the fourth medical information to the second server.

20. The method of claim 14, further comprising transmitting network information of the mobile device to at least one of the first medical device and the first server,
wherein the receiving of the first medical information is performed based on the network information.

21. A method of managing personal medical information via a medical device, the method comprising:
performing an examination of a first user;
receiving a request for first medical information, the first medical information being a result of the examination, from at least one of a mobile device and a first server; and
transmitting the first medical information to at least one of the mobile device and the first server.

22. The method of claim 21, wherein the performing of the examination comprises:
receiving first identification information of the first user from the at least one of the mobile device and the first server; and
performing the examination in correspondence to the first identification information.

23. The method of claim 22, wherein the transmitting of the first medical information comprises:
receiving second identification information of the first user from the at least one of the mobile device and the first server; and
if the first identification information and the second identification information correspond to each other, transmitting the first medical information to the mobile device.

24. A non-transitory computer-readable recording medium having embodied thereon a computer program for executing the method of claim 14.

25. A non-transitory computer-readable recording medium having embodied thereon a computer program for executing the method of claim 21.

26. A method of managing medical information, the method comprising:
receiving a request from a mobile device for first medical information, the first medical information being a result of an examination of a user by a medical device;
receiving from the mobile device first identification information of the first user;
transmitting to the medical device the first identification information to the first user;
receiving the first medical information from the first medical device;
transmitting the first medical information to the mobile device.

27. The method of claim 26, wherein the transmitting of the first medical information comprises:
receiving second identification information of the first user; and
transmitting the first medical information if the first identification information and the second identification information correspond to each other.

28. The method of claim 26, further comprising:
transmitting a request for third medical information to the mobile device;
transmitting a retention information to the mobile device; and
receiving the third medical information from the mobile device.
